(19) United States
(12) Patent Application Publication
(10) Pub. No.: US 2021/0191001 A1
(43) Pub. Date: Jun. 24, 2021

(54) STRUCTURES FOR LASER BONDING AND LIQUID LENSES COMPRISING SUCH STRUCTURES

(71) Applicant: CORNING INCORPORATED, CORNING, NY (US)

(72) Inventor: Robert Alan Bellman, Ithaca, NY (US)

(21) Appl. No.: 17/054,581

(22) PCT Filed: May 15, 2019
(86) PCT No.: PCT/US2019/032494

§ 371 Date: Nov. 11, 2020

Related U.S. Application Data
(60) Provisional application No. 62/674,526, filed on May 21, 2018.

(51) Int. Cl. G02B 3/14; B23K 26/324; G02B 26/00

(52) U.S. Cl. CPC G02B 3/14; G02B 26/005; B23K 26/324

(57) ABSTRACT

A liquid lens includes a substrate and a structure deposited on the substrate. The structure includes an electrically conductive layer disposed on the substrate, and an electromagnetic absorber layer disposed on the electrically conductive layer. The structure exhibits a reflectivity minimum of about less than 1% at a visible wavelength within a visible wavelength range of 390 nm to 700 nm, and a reflectively of about 25% or less at an ultra-violet wavelength within an ultra-violet wavelength range of 100 nm to 400 nm. Methods of manufacturing the liquid lens and methods of operating the liquid lens are also provided.

### CROSS-REFERENCE TO RELATED APPLICATIONS

This application claims the benefit of priority under 35 U.S.C. § 119 of U.S. Provisional Application No. 62/674,526, filed May 21, 2018, the content of which is incorporated herein by reference in its entirety.

### FIELD

The present disclosure relates generally structures for laser bonding, liquid lenses comprising such structures, and methods for manufacturing and operating liquid lenses.

### BACKGROUND

Liquid lenses generally include two immiscible liquids disposed within a cavity of a lens body. Varying the electric field to which the liquids are subjected can vary the wettability of one of the liquids with respect to a surface within the cavity and can, thereby, vary a shape of an interface (e.g., liquid lens) formed between the two liquids. The liquid lens can function and, therefore, be employed as an optical lens in a variety of applications.

### SUMMARY

The following presents a simplified summary of the disclosure to provide a basic understanding of some embodiments described in the detailed description.

In some embodiments, a liquid lens can comprise a substrate and a structure disposed on the substrate. The structure can comprise an electrically conductive layer disposed on the substrate and an electromagnetic absorber layer disposed on the electrically conductive layer. The structure can exhibit a reflectivity minimum of about less than 1% at a visible wavelength within a visible wavelength range of 390 nm to 700 nm, and a reflectively of about 25% or less at an ultra-violet wavelength within an ultra-violet wavelength range of 100 nm to 400 nm.

In some embodiments, the visible wavelength can be within a narrowed visible wavelength range of 550 nm to 620 nm, and the ultra-violet wavelength can be about 355 nm.

In some embodiments, the reflectively at the ultra-violet wavelength can be about 10% or less.

In some embodiments, the electrically conductive layer can comprise a first electrically conductive layer comprising Ti disposed on the first glass substrate. The electrically conductive layer can further comprise a second electrically conductive layer comprising Cu disposed on the first electrically conductive layer. The electrically conductive layer can further comprise a third electrically conductive layer comprising Ti disposed on the second electrically conductive layer.

In some embodiments, the electromagnetic absorber layer can comprise a first electromagnetic absorber layer comprising Cr disposed on the electrically conductive layer. The electromagnetic absorber layer can further comprise a second electromagnetic absorber layer comprising CrON disposed on the first electromagnetic absorber layer. The electromagnetic absorber layer can further comprise a third electromagnetic absorber layer comprising Cr2O3 disposed on the second electromagnetic absorber layer.

In some embodiments, a thickness of the first electrically conductive layer can be about 10 nm, a thickness of the second electrically conductive layer can be about 100 nm, and a thickness of the third electrically conductive layer can be about 30 nm. A thickness of the first electromagnetic absorber layer can be from about 10 nm to about 11 nm. A thickness of the second electromagnetic absorber layer can be from about 33 nm to about 34 nm. A thickness of the third electromagnetic absorber layer can be from about 22 nm to about 23 nm.

In some embodiments, etching the electromagnetic absorber layer in Transene 1020 at 30° C. can expose the electrically conductive layer in less than about 5 seconds.

In some embodiments, a second substrate can be disposed on the electromagnetic absorber layer such that the structure is disposed between the substrate and the second substrate. A bond can be defined at least in part by the structure. The bond can hermetically seal the substrate and the second substrate.

In some embodiments, at least one of the substrate or the second substrate can comprise a glass substrate.

In some embodiments, a cavity can be defined at least in part by the bond. A polar liquid and a non-polar liquid can be disposed within the cavity. The polar liquid and the non-polar liquid can be substantially immiscible such that an interface between the polar liquid and the non-polar liquid defines a lens of the liquid lens.

In some embodiments, a method of operating the liquid lens can comprise subjecting the polar liquid and the non-polar liquid to an electric field. The method can further comprise adjusting the electric field to change a shape of the interface.

In some embodiments, a method of manufacturing a liquid lens can comprise applying a structure to a glass substrate by applying an electrically conductive layer of the structure to the glass substrate and applying an electromagnetic absorber layer of the structure to the electrically conductive layer. The structure can exhibit a reflectivity minimum of about less than 1% at a visible wavelength within a visible wavelength range of 390 nm to 700 nm, and a reflectively of about 25% or less at an ultra-violet wavelength within an ultra-violet wavelength range of 100 nm to 400 nm.

In some embodiments, the visible wavelength can be within a narrowed visible wavelength range of 550 nm to 620 nm, and the ultra-violet wavelength can be about 355 nm.

In some embodiments, the reflectively at the ultra-violet wavelength can be about 10% or less.

In some embodiments, applying the electrically conductive layer can comprise applying a first electrically conductive layer comprising Ti to the glass substrate. The method of applying the electrically conductive layer can further comprise applying a second electrically conductive layer comprising Cu to the first electrically conductive layer. The method of applying the electrically conductive layer can further comprise applying a third electrically conductive layer comprising Ti to the second electrically conductive layer.

In some embodiments, applying the electromagnetic absorber layer can comprise applying a first electromagnetic absorber layer comprising Cr to the electrically conductive layer. The method of applying can further include applying a second electromagnetic absorber layer comprising CrON to the first electromagnetic absorber layer. The method of applying can further comprise applying a third electromagnetic absorber layer comprising Cr2O3 to the second electromagnetic absorber layer.

In some embodiments, the method can comprise applying an etchant comprising Transene 1020 at 30° C. to the electromagnetic absorber layer, thereby exposing the electrically conductive layer in less than about 5 seconds.

In some embodiments, the method can comprise adding a polar liquid and a non-polar liquid to a cavity of the liquid lens defined at least in part by the glass substrate. The polar liquid and the non-polar liquid can be substantially immiscible such that an interface is defined between the polar liquid and the non-polar liquid.

In some embodiments, the method can comprise positioning a second glass substrate on the electromagnetic absorber layer. The method can further comprise bonding the glass substrate and the second glass substrate at least in part by irradiating the structure with a laser beam.

In some embodiments, the method can comprise changing a shape of the interface by adjusting an electric field to which the polar liquid and the non-polar liquid are subjected.

In some embodiments, a bonded article can comprise a first substrate, a second substrate, and a structure disposed between the first substrate and the second substrate. The structure can comprise an electrically conductive layer and an electromagnetic absorber layer. The structure can exhibit a reflectivity minimum of about less than 1% at a visible wavelength within a visible wavelength range of 390 nm to 700 nm, and a reflectively of about 25% or less at an ultra-violet wavelength within an ultra-violet wavelength range of 100 nm to 400 nm.

In some embodiments, at least one of the first substrate or the second substrate can comprise a glass-based material.

In some embodiments, the visible wavelength can be within a narrowed visible wavelength range of 550 nm to 620 nm, and the ultra-violet wavelength can be about 355 nm.

In some embodiments, the reflectively at the ultra-violet wavelength can be about 10% or less.

In some embodiments, the electrically conductive layer can comprise a first electrically conductive layer comprising Ti disposed on the first substrate. The electrically conductive layer can further comprise a second electrically conductive layer comprising Cu disposed on the first electrically conductive layer. The electrically conductive layer can further comprise a third electrically conductive layer comprising Ti disposed on the second electrically conductive layer.

In some embodiments, the electromagnetic absorber layer can comprise a first electromagnetic absorber layer comprising Cr disposed on the electrically conductive layer. The electromagnetic absorber layer can further comprise a second electromagnetic absorber layer comprising CrON disposed on the first electromagnetic absorber layer. The electromagnetic absorber layer can still further comprise a third electromagnetic absorber layer comprising Cr2O3 disposed on the second electromagnetic absorber layer.

In some embodiments, a thickness of the first electrically conductive layer can be about 10 nm, a thickness of the second electrically conductive layer can be about 100 nm, and a thickness of the third electrically conductive layer can be about 30 nm. A thickness of the first electromagnetic absorber layer can be from about 10 nm to about 11 nm, a thickness of the second electromagnetic absorber layer can be from about 33 nm to about 34 nm, and a thickness of the third electromagnetic absorber layer can be from about 22 nm to about 23 nm.

In some embodiments, etching the electromagnetic absorber layer in Transene 1020 at 30° C. can expose the electrically conductive layer in less than about 5 seconds.

In some embodiments, the bonded article can comprise a hermetically sealed package.

In some embodiments, a liquid can be disposed within the hermetically sealed package.

### BRIEF DESCRIPTION OF THE DRAWINGS

These and other features, embodiments and advantages are better understood when the following detailed description is read with reference to the accompanying drawings, in which:

FIG. 1 schematically illustrates a cross-sectional view of an exemplary embodiment a liquid lens in accordance with embodiments of the disclosure;

FIG. 2 shows a top (plan) view of the liquid lens along line 2-2 of FIG. 1 in accordance with embodiments of the disclosure;

FIG. 3 shows a bottom view of the liquid lens along line 3-3 of FIG. 1 in accordance with embodiments of the disclosure;

FIG. 4 shows an enlarged view of a portion of the liquid lens taken at view 4 of FIG. 1, including a bond in accordance with embodiments of the disclosure;

FIG. 5 shows an exemplary method of manufacturing the bond of FIG. 4 including applying a conductive layer in accordance with embodiments of the disclosure;

FIG. 6 shows an exemplary method of manufacturing the bond of FIG. 4 including applying an absorber layer to the conductive layer of FIG. 5 to provide a dark mirror structure in accordance with embodiments of the disclosure;

FIG. 7 shows an exemplary method of manufacturing the bond of FIG. 4 including a method of laser bonding the dark mirror structure of FIG. 6 in accordance with embodiments of the disclosure;

FIG. 8 shows an exemplary embodiment of a portion of the liquid lens including the bond manufactured by the exemplary methods of FIGS. 5-7 after the method of laser bonding the dark mirror structure of FIG. 7 in accordance with embodiments of the disclosure;

FIG. 9 shows an exemplary method of manufacturing an electrical contact taken at cross-sectional view 9-9 of FIG. 2 including a method of applying an etchant to the absorber layer of the dark mirror structure of FIG. 6 in accordance with embodiments of the disclosure; and

FIG. 10 shows an exemplary embodiment of the electrical contact formed by the method of applying an etchant to the absorber layer of the dark mirror structure of FIG. 9 in accordance with embodiments of the disclosure.

### DETAILED DESCRIPTION

Embodiments will now be described more fully hereinafter with reference to the accompanying drawings in which exemplary embodiments are shown. Whenever possible, the same reference numerals are used throughout the drawings to refer to the same or like parts. However, this disclosure may be embodied in many different forms and should not be construed as limited to the embodiments set forth herein.

Embodiments of the disclosure can include bonded articles that may be employed in a wide range of applications. For instance, bonded articles of the disclosure can include hermetically sealed packages that can contain fluid, such as a liquid, that may be prevented from leaking out of the hermetically sealed package and/or protected from contaminants from outside of the hermetically sealed package. Embodiments throughout the disclosure discuss bonded articles in the form of liquid lenses, although other bonded articles may be provided in further embodiments. Throughout the disclosure, features described with respect to the liquid lenses can be included with features of other bonded articles.

It is to be understood that specific embodiments disclosed herein are intended to be exemplary and therefore non-limiting. For purposes of the disclosure, in some embodiments, a liquid lens and methods for manufacturing and operating a liquid lens can be provided. Although a single liquid lens is described and illustrated in the drawing figures, unless otherwise noted, it is to be understood that, in some embodiments, a plurality of liquid lenses can be provided, and one or more of the plurality of liquid lenses can include the same or similar features as the single liquid lens, without departing from the scope of the disclosure.

For example, in some embodiments, the plurality of liquid lenses can be manufactured more efficiently (e.g., simultaneously, faster, less expensively, in parallel) as an array (e.g., based on micro-electro-mechanical system (MEMs) wafer scale fabrication) including the plurality of liquid lenses. For example, as compared to manufacturing a plurality of single liquid lenses manually (e.g., by human hand) or individually and separately, in some embodiments, an array including the plurality of liquid lenses can be manufactured automatically by a micro-electro-mechanical system including a controller (e.g., computer, robot), thereby increasing one or more of the manufacturing efficiency, the rate of production, the scalability, and the repeatability of the manufacturing process.

Moreover, in some embodiments, for example, after manufacturing the array including the plurality of liquid lenses, one or more liquid lenses can be separated from the array (e.g., singulation) and provided as a single liquid lens in accordance with embodiments of the disclosure. In some embodiments, whether manufactured as a single liquid lens or an array including a plurality of liquid lenses, the liquid lens of the present disclosure can be provided, manufactured, operated, and employed in accordance with embodiments of the disclosure without departing from the scope of the disclosure.

The present disclosure relates generally to a liquid lens and methods for manufacturing and operating a liquid lens. Apparatus including a liquid lens including a conductive layer and an insulative layer as well as methods for manufacturing and operating a liquid lens including a conductive layer and an insulative layer will now be described by way of exemplary embodiments in accordance with the disclosure.

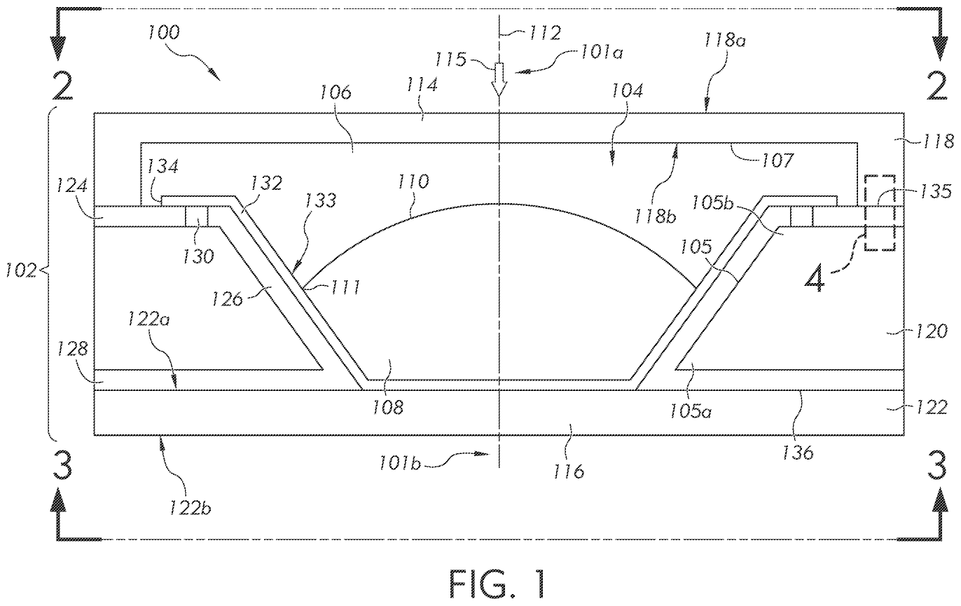

As schematically illustrated, FIG. 1 shows a schematic cross-sectional view of an exemplary embodiment of a liquid lens 100 in accordance with embodiments of the disclosure. For visual clarity, cross-hatching of features of the cross-sectional view of FIG. 1 is omitted. In some embodiments, the liquid lens 100 can include a lens body 102 and a cavity 104 defined (e.g., formed) in the lens body 102. In some embodiments, the liquid lens 100 can include a plurality of components that, either alone or in combination, define the lens body 102. Unless otherwise noted, in some embodiments, a variety of shapes and sizes of the lens body 102 can be provided without departing from the scope of the disclosure. In some embodiments, the lens body 102 can define a circular shape (shown), although other shapes including but not limited to, rectangular, square, oval, cylindrical, cuboidal, or other two-dimensional or three-dimensional geometric shape. Likewise, in some embodiments, the lens body 102 can define dimensions on the order of centimeters, millimeters, micrometers, or other sizes suitable for lenses, including but not limited to, camera lenses for hand-held electronic devices or other electronic devices including one or more lenses in accordance with embodiments of the disclosure.

For example, in some embodiments, the liquid lens 100 can include a first outer layer 118, an intermediate layer 120, and a second outer layer 122 that, either alone or in combination, define the lens body 102. In some embodiments, the intermediate layer 120 can be disposed between the first outer layer 118 and the second outer layer 122 with the cavity 104 defined, at least in part, by an internal space (e.g., void, volume) provided in the intermediate layer 120 and bounded on a first side (e.g., an object side 101a) of the liquid lens 100 by the first outer layer 118, and bounded on a second side (e.g., an image side 101b) of the liquid lens 100 by the second outer layer 122. In some embodiments, the intermediate layer 120 can include (e.g., be manufactured from) one or more of a metallic material, polymeric material, glass material, ceramic material, or glass-ceramic material. Additionally, in some embodiments, the intermediate layer 120 can include (e.g., be manufactured to include) a bore 105 (e.g., aperture) forming a space defining, at least in part, a portion of the cavity 104 between the first outer layer 118 and the second outer layer 122.

In some embodiments, the bore 105 formed in the intermediate layer 120 can include a narrow end 105a and a wide end 105b. Unless otherwise noted, in some embodiments, the narrow end 105a can define a smaller dimension (e.g., diameter) of the bore 105 relative to a corresponding dimension (e.g., diameter) defined by the wide end 105b of the bore 105. For example, in some embodiments, the bore 105 and the cavity 104 can be tapered such that a cross-sectional area of the bore 105 and the cavity 104 decrease along an optical axis 112 of the liquid lens 100 in a direction extending from the object side 101a of the liquid lens 100 to the image side 101b of the liquid lens 100. Additionally, in some embodiments (not shown), the bore 105 and the cavity 104 can be tapered such that a cross-sectional area of the bore 105 and the cavity 104 increase along the optical axis 112 in a direction extending from the image side 101b of the liquid lens 100 to the object side 101a of the liquid lens 100. Moreover, in some embodiments (not shown), the bore 105 and the cavity 104 can be non-tapered such that a cross-sectional area of the bore 105 and the cavity 104 are substantially constant along the optical axis 112.

In some embodiments, the lens body 102 can include a first window 114 defined between a first major surface 118a of the first outer layer 118 and a second major surface 118b of the first outer layer 118. Similarly, in some embodiments, the lens body 102 can include a second window 116 defined between a first major surface 122a of the second outer layer 122 and a second major surface 122b of the second outer layer 122. Thus, in some embodiments, at least a portion of the first outer layer 118 can define the first window 114, and at least a portion of the second outer layer 122 can define the second window 116. In some embodiments, the first window 114 can define the object side 101a of the liquid lens 100, and the second window 116 can define the image side 101b of the liquid lens 100. For example, in some embodiments, the first major surface 118a of the first outer layer 118 can face the object side 101a of the liquid lens 100, and the second major surface 122b of the second outer layer 122 can face the image side 101b of the liquid lens 100. Thus, in some embodiments, the cavity 104 can be disposed between the first window 114 and the second window 116. For example, in some embodiments, the second major surface 118b of the first outer layer 118 can be spaced a non-zero distance from and face the first major surface 122a of the second outer layer 122. Accordingly, in some embodiments, the cavity 104 can be defined, either alone or in combination, as at least a portion of the space (e.g., volume) between the second major surface 118b of the first outer layer 118 and the first major surface 122a of the second outer layer 122, including the space defined by the bore 105 formed in the intermediate layer 120.

Moreover, although the lens body 102 of the liquid lens 100 is schematically illustrated as including the first outer layer 118, the intermediate layer 120, and the second outer layer 122, other components and configurations can be provided in further embodiments, without departing from the scope of the disclosure. For example, in some embodiments, one or more of the outer layers 118, 122 can be omitted, and the bore 105 in the intermediate layer 120 can be provided as a blind hole that does not extend entirely through the intermediate layer 120. Likewise, although the first portion of the cavity 104 is schematically illustrated as being disposed within the recess 107 of the first outer layer 118, other embodiments can be provided in further embodiments, without departing from the scope of the disclosure. For example, in some embodiments, the recess 107 can be omitted, and the first portion of the cavity 104 can be disposed within the bore 105 in the intermediate layer 120. Thus, in some embodiments, the first portion of the cavity 104 can be defined as an upper portion of the bore 105, and the second portion of the cavity 104 can be defined as a lower portion of the bore 105. In some embodiments, the first portion of the cavity 104 can be disposed partially within the bore 105 of the intermediate layer 120 and partially outside the bore 105.

In some embodiments, the cavity 104 can include a first portion (e.g., headspace) and a second portion (e.g., base region). For example, in some embodiments, the first portion of the cavity 104 can be defined, based at least in part, as a space (e.g., volume) provided by a recess 107 in the first outer layer 118. In addition or alternatively, in some embodiments, the first portion of the cavity 104 can be defined, based at least in part, as a space provided by at least a portion of the bore 105 formed in the intermediate layer 120 bounded by the first outer layer 118 and the second portion. Likewise, in some embodiments, the second portion of the cavity 104 can be defined, based at least in part, as a space (e.g., volume) provided by at least a portion of the bore 105 formed in the intermediate layer 120 bounded by the second outer layer 122 and the first portion.

In some embodiments, the cavity 104 can be sealed (e.g., hermetically sealed) within the lens body 102. For, example, in some embodiments, the first outer layer 118 can be bonded to the intermediate layer 120 at a first bond 135. In addition or alternatively, in some embodiments, the second outer layer 122 can be bonded to the intermediate layer 120 at a second bond 136. In some embodiments, at least one of the first bond 135 and the second bond 136 can include one or more of an adhesive bond, a laser bond (e.g., a laser weld), or other suitable bond to seal (e.g., hermetically seal) the first outer layer 118 to the intermediate layer 120 at bond 135 and to seal (e.g., hermetically seal) the second outer layer 122 to the intermediate layer 120 at bond 136. Accordingly, in some embodiments, the cavity 104 formed in the lens body 102, including contents disposed within the cavity 104, can be hermetically sealed and isolated with respect to an environment in which the liquid lens 100 may be employed.

In some embodiments, the liquid lens 100 can include a conductive layer 128 and an insulative layer 132. In some embodiments, at least a portion of the conductive layer 128 and at least a portion of the insulative layer 132 can be disposed within the cavity 104. For example, in some embodiments, the conductive layer 128 can include an electrically conductive coating applied to the intermediate layer 120. In some embodiments, the conductive layer 128 can include (e.g., be manufactured from) one or more of an electrically conductive metallic material, an electrically conductive polymer material, or other suitable electrically conductive material. In addition or alternatively, in some embodiments, the conductive layer 128 can include a single layer or a plurality of layers, at least one or more of which can be electrically conductive.

Similarly, in some embodiments, the insulative layer 132 can include an electrically insulative (e.g., dielectric) coating applied to the intermediate layer 120. For example, in some embodiments, the insulative layer 132 can include an electrically insulative coating applied to at least a portion of the conductive layer 128 and to at least a portion of the first major surface 122a of the second outer layer 122. In some embodiments, the insulative layer 132 can include (e.g., be manufactured from) one or more of polytetrafluoroethylene (PTFE) material, parylene material, or other suitable polymeric or non-polymeric electrically insulative material. In addition or alternatively, in some embodiments, the insulative layer 132 can include a single layer or a plurality of layers, at least one or more of which can be electrically insulative. Moreover, in some embodiments, the insulative layer 132 can include (e.g., be manufactured from) a hydrophobic material. In addition or alternatively, in some embodiments the insulative layer 132 can include (e.g., be manufactured from) a hydrophilic material including a surface coating or surface treatment providing an exposed surface 133 of the insulative layer 132 in contact with, for example, the contents within the cavity 104, with hydrophobic material properties.

In some embodiments, the conductive layer 128 can be applied to the intermediate layer 120 prior to bonding at least one of the first outer layer 118 to the intermediate layer 120 (e.g., bond 135) and the second outer layer 122 to the intermediate layer 120 (e.g., bond 136). Likewise, in some embodiments, the insulative layer 132 can be applied to the intermediate layer 120 prior to bonding at least one of the first outer layer 118 to the intermediate layer 120 and the second outer layer 122 to the intermediate layer 120. In some embodiments, the insulative layer 132 can be applied to at least a portion of the conductive layer 128 and to at least a portion of the first major surface 122a of the second outer layer 122 prior to bonding at least one of the first outer layer 118 to the intermediate layer 120 and the second outer layer 122 to the intermediate layer 120. Alternatively, in some embodiments, the insulative layer 132 can be applied to at least a portion of the conductive layer 128 and to at least a portion of the first major surface 122a of the second outer layer 122 after bonding the second outer layer 122 to the intermediate layer 120 and prior to bonding the first outer layer 118 to the intermediate layer 120. Thus, in some embodiments, the insulative layer 132 can cover at least a portion of the conductive layer 128 and at least a portion of the first major surface 122a of the second outer layer 122 within the cavity 104.

In some embodiments, the conductive layer 128 can define at least one of a common electrode 124 and a driving electrode 126. For example, in some embodiments, the conductive layer 128 can be applied to substantially an entire surface of the intermediate layer 120 including a sidewall of the bore 105 prior to bonding at least one of the first outer layer 118 and the second outer layer 122 to the intermediate layer 120. Additionally, in some embodiments, after applying the conductive layer 128 to the intermediate layer 120, the conductive layer 128 can be segmented into one or more electrically isolated conductive elements including, but not limited to, the common electrode 124 and the driving electrode 126.

For example, in some embodiments, the liquid lens 100 can include a scribe 130 formed in the conductive layer 128 to isolate (e.g., electrically isolate) the common electrode 124 from the driving electrode 126. In some embodiments, the scribe 130 can include a gap (e.g., space) in the conductive layer 128. For example, in some embodiments, the scribe 130 can define a gap in the conductive layer 128 between the common electrode 124 and the driving electrode 126. In some embodiments, a dimension (e.g., width) of the scribe 130 can be about 5 μm (micrometers), about 10 μm, about 15 μm, about 20 μm, about 25 μm, about 30 μm, about 35 μm, about 40 μm, about 45 μm, about 50 μm, including all ranges and subranges therebetween.

Additionally, in some embodiments, a first liquid 106 and a second liquid 108 can be disposed within the cavity 104. For example, in some embodiments, at least a quantity (e.g., volume) of the first liquid 106 can be disposed in at least a portion of the first portion of the cavity 104. Likewise, in some embodiments, at least a quantity (e.g., volume) of the second liquid 108 can be disposed in at least a portion of the second portion of the cavity 104. For example, in some embodiments, substantially all or a predetermined amount of a quantity of the first liquid 106 can be disposed in the first portion of the cavity 104, and substantially all or a predetermined amount of a quantity of the second liquid 108 can be disposed in the second portion of the cavity 104.

As noted, in some embodiments, the cavity 104 can be sealed (e.g., hermetically sealed) within the lens body 102. Accordingly, in some embodiments, the first liquid 106 and the second liquid 108 can be disposed within the cavity 104 prior to hermetically sealing the lens body 102 to, thereby, define the hermetically sealed cavity 104 including the first liquid 106 and the second liquid 108 disposed within the hermetically sealed cavity 104.

For example, in some embodiments, the second outer layer 122 can be bonded to the intermediate layer 120 at the second bond 136, and then the first liquid 106 and the second liquid 108 can be added to the region of the cavity 104 provided by bonding the second outer layer 122 and the intermediate layer 120 at the second bond 136. In some embodiments, bonding the second outer layer 122 to the intermediate layer 120 at the second bond 136 can seal (e.g., hermetically seal) the second outer layer 122 to the intermediate layer 120 at the bond 136. Additionally, in some embodiments, after adding the first liquid 106 and the second liquid 108 to the region of the cavity 104, the first outer layer 118 can then be bonded to the intermediate layer 120 at the first bond 135. In some embodiments, bonding the first outer layer 118 and the intermediate layer 120 at the first bond 135 can seal (e.g., hermetically seal) the first outer layer 118 to the intermediate layer 120 at the first bond 135. Accordingly, in some embodiments, the cavity 104 formed in the lens body 102, including the first liquid 106 and the second liquid 108 disposed within the cavity 104, can be hermetically sealed and isolated with respect to an environment in which the liquid lens 100 may be employed.

Alternatively, in some embodiments, the first outer layer 118 can be bonded to the intermediate layer 120 at the first bond 135, and then the first liquid 106 and the second liquid 108 can be added to the region of the cavity 104 provided by bonding the first outer layer 118 to the intermediate layer 120 at the first bond 135. In some embodiments, bonding the first outer layer 118 to the intermediate layer 120 at the first bond 135 can seal (e.g., hermetically seal) the first outer layer 118 to the intermediate layer 120 at the first bond 135. Additionally, in some embodiments, after adding the first liquid 106 and the second liquid 108 to the region of the cavity 104, the second outer layer 122 can then be bonded to the intermediate layer 120 at the second bond 136. In some embodiments, bonding the second outer layer 122 and the intermediate layer 120 at the second bond 136 can seal (e.g., hermetically seal) the second outer layer 122 and the intermediate layer 120 at the second bond 136. Accordingly, in some embodiments, the cavity 104 formed in the lens body 102, including the first liquid 106 and the second liquid 108 disposed within the cavity 104, can be hermetically sealed and isolated with respect to an environment in which the liquid lens 100 may be employed.

Additionally, in some embodiments, the first liquid 106 can be a low index, polar liquid or a conducting liquid (e.g., water). In addition or alternatively, in some embodiments, the second liquid 108 can be a high index, non-polar liquid or an insulating liquid (e.g., oil). Moreover, in some embodiments, the first liquid 106 and the second liquid 108 can be immiscible with respect to each other and can have different refractive indices (e.g., water and oil). Thus, in some embodiments, the boundary (e.g., meniscus) of the first liquid 106 and the second liquid 108 can define an interface 110. In some embodiments, the interface 110 defined between the first liquid 106 and the second liquid 108 can define (e.g., include one or more characteristics of) a lens (e.g., a liquid lens). In some embodiments, a perimeter 111 of the interface 110 (e.g., an edge of the interface 110 in contact with a sidewall of the bore 105 of the cavity 104) can be disposed in the first portion of the cavity 104 and/or in the second portion of the cavity 104 in accordance with embodiments of the disclosure. Additionally, in some embodiments, the first liquid 106 and the second liquid 108 can have substantially the same density. In some embodiments, providing the first liquid 106 and the second liquid 108 with substantially the same density can help to avoid changes in a shape of the interface 110 based at least in part on, for example, gravitational forces acting on the first liquid 106 and the second liquid 108 with respect to a physical orientation of the liquid lens 100 relative to the direction of gravity.

In some embodiments, within the cavity 104, the common electrode 124 can be in electrical communication with the first liquid 106. Additionally, in some embodiments, the driving electrode 126 can be disposed on a sidewall of the bore 105 within the cavity 104 and can be electrically insulated from the first liquid 106 and the second liquid 108, for example, by the insulative layer 132. For example, in some embodiments, within the cavity 104, the insulative layer 132 can cover one or more of the driving electrode 126 of the conductive layer 128, at least a portion of the first major surface 122a of the second outer layer 122, the scribe 130, and at least a portion of the common electrode 124 of the conductive layer 128. Additionally, in some embodiments, at least a portion of the common electrode 124 can be uncovered with respect to the insulative layer 132 to expose a non-insulated portion of the common electrode 124 to the cavity 104, thereby providing the non-insulated portion of the common electrode 124 in electrical communication with the first liquid 106. For example, in some embodiments, the insulative layer 132 can include a perimeter or boundary 134 (e.g., edge, outer edge) defining a location corresponding to the uncovered portion of the common electrode 124 with respect to the insulative layer 132.

Thus, in some embodiments, within the cavity 104, the first liquid 106 can be in electrical communication with the common electrode 124 of the conductive layer 128, the second liquid 108 can be electrically isolated from the common electrode 124 by the insulative layer 132, and the first liquid 106 and the second liquid 108 can be electrically isolated from the driving electrode 126 of the conductive layer 128 by the insulative layer 132. Moreover, in some embodiments, the exposed surface 133 of the insulative layer 132 can be in contact with the first liquid 106 and the second liquid 108.

Accordingly, in some embodiments, the liquid lens defined as the interface 110 between the first liquid 106 and the second liquid 108 can be adjusted based, at least in part, by electrowetting. In some embodiments, electrowetting can be defined as controlling the wettability of the first liquid 106 with respect to the exposed surface 133 of the insulative layer 132 by controlling a voltage of the common electrode 124 and the driving electrode 126. For example, in some embodiments, different voltages can be supplied to the common electrode 124 and to the driving electrode 126 to define one or more electric fields to which the first liquid 106 and the second liquid 108 can be subjected. Accordingly, in some embodiments, the one or more electric fields to which the first liquid 106 and the second liquid 108 can be subjected can be employed to change a shape (e.g., profile) of the interface 110 based, at least in part, by electrowetting.

In some embodiments, a controller (not shown) can be configured to provide a first voltage (e.g., common voltage) to the common electrode 124 and, therefore, to the first liquid 106 in electrical communication with the common electrode 124. In some embodiments, the controller can be configured to provide a second voltage (e.g., driving voltage) to the driving electrode 126 electrically isolated from the first liquid 106 and the second liquid 108 by the insulative layer 132. In some embodiments, the voltage difference between the common electrode 124 (including the first liquid 106) and the driving electrode 126 can define a shape of the interface 110 in accordance with embodiments of the disclosure. Moreover, in some embodiments, the common voltage and/or the driving voltage can include an oscillating voltage signal (e.g., a square wave, a sine wave, a triangle wave, a sawtooth wave, or another oscillating voltage signal). In some of such embodiments, the voltage differential between the common electrode 124 and the driving electrode 126 can include a root mean square (RMS) voltage differential. In addition or alternatively, in some embodiments, the voltage differential between common electrode 124 and the driving electrode 126 can be manipulated based on a pulse width modulation (e.g., by manipulating a duty cycle of the differential voltage signal).

In some embodiments, controlling the voltage of the common electrode 124 (including the first liquid 106) and the driving electrode 126 can increase or decrease the wettability of the first liquid 106 with respect to the exposed surface 133 of the insulative layer 132 within the cavity 104 and, therefore, change the shape of the interface 110. For example, in some embodiments, hydrophobic characteristics of the exposed surface 133 of the insulative layer 132 can help to maintain the second liquid 108 within the second portion of the cavity 104 based on attraction between the non-polar second liquid 108 and the hydrophobic exposed surface 133. Likewise, in some embodiments, hydrophobic characteristics of the exposed surface 133 of the insulative layer 132 can enable the perimeter 111 of the interface 110 to move along the hydrophobic exposed surface 133 based, at least in part, on an increase or decrease of the wettability of the first liquid 106 with respect to the exposed surface 133 of the insulative layer 132 within the cavity 104. Accordingly, in some embodiments, based at least in part on electrowetting, one or more features of the disclosure can be provided, either alone or in combination, to move the perimeter 111 of the interface 110 along the hydrophobic exposed surface 133 and, therefore, control (e.g., maintain, change, adjust) the shape of the liquid lens defined as the interface 110 between the first liquid 106 and the second liquid 108 within the cavity 104 of the liquid lens 100 in accordance with embodiments of the disclosure.

In some embodiments, controlling the shape of the interface 110 can control one or more of a zoom and a focal length or focus (e.g., at least one of a diopter and a tilt) of the liquid lens defined by the interface 110 of the liquid lens 100. For example, in some embodiments, controlling the focal length or focus, by controlling the shape of the interface 110, can enable the liquid lens 100 to perform an autofocus function. In addition or alternatively, in some embodiments, controlling the shape of the interface 110 can tilt the interface 110 relative to the optical axis 112 of the liquid lens 100. For example, in some embodiments, tilting the interface 110 relative to the optical axis 112 can enable the liquid lens 100 to perform an optical image stabilization (OIS) function. Additionally, in some embodiments, the shape of the interface 110 can be controlled without physical movement of the liquid lens 100 relative to, for example, one or more of an image sensor, a fixed lens, a lens stack, a housing, and other components of a camera module in which the liquid lens 100 can be incorporated and employed.

In some embodiments, image light (represented by arrow 115) can enter the object side 101a of the liquid lens 100 through the first window 114, be refracted at the interface 110 between the first liquid 106 and the second liquid 108 defining the liquid lens, and exit the image side 101b of the liquid lens 100 through the second window 116. In some embodiments, the image light 115 can travel in a direction extending along the optical axis 112. Thus, in some embodiments, at least one of the first outer layer 118 and the second outer layer 122 can include an optical transparency to enable passage of the image light 115 into, through, and out of the liquid lens 100 in accordance with embodiments of the disclosure. For example, in some embodiments, at least one of the first outer layer 118 and the second outer layer 122 can include (e.g., be manufactured from) one or more optically transparent materials including, but not limited to, a polymeric material, a glass material, a ceramic material, or a glass-ceramic material. Likewise, in some embodiments, the insulative layer 132 can include an optical transparency to enable passage of the image light 115 from the interface 110 through the insulative layer 132 and into the second window 116. Additionally, in some embodiments, the image light 115 can pass through the bore 105 formed in the intermediate layer 120, and the intermediate layer 120 can, therefore, optionally include an optical transparency.

In some embodiments, outer surfaces of the liquid lens 100 can be planar as compared to being non-planar (e.g., curved) as with, for example, outer surfaces of a fixed lens (not shown). For example, in some embodiments, as schematically illustrated, at least one of the first major surface 118a and the second major surface 118b of the first outer layer 118 and at least one of the first major surface 122a and the second major surface 122b of the second outer layer 122 can be substantially planar. Accordingly, in some embodiments, the liquid lens 100 can include planar outer surfaces while, nonetheless, operating and functioning as a curved lens by, for example, refracting image light 115 passing through the interface 110 which can include a curved (e.g., concave, convex) shape in accordance with embodiments of the disclosure. However, in some embodiments, outer surfaces of at least one of the first outer layer 118 and the second outer layer 122 can be non-planar (e.g., curved, concave, convex) without departing from the scope of the disclosure. Thus, in some embodiments, the liquid lens 100 can include an integrated fixed lens or other optical components (e.g., filters, lens, protective coatings, scratch resistant coatings) provided, alone or in combination with the liquid lens defined as the interface 110, to provide a liquid lens 100 in accordance with embodiments of the disclosure.

In some embodiments, one or more control devices (not shown) including, but not limited to, a controller, a driver, a sensor (e.g., capacitance sensor, temperature sensor), or other mechanical, electronic, or electro-mechanical component of a lens or camera system, can be provided in accordance with embodiments of the disclosure to, for example, operate one or more features of the liquid lens 100. For example, in some embodiments, a control device can be provided and electrically connected to the conductive layer 128 to, for example, operate one or more features of the liquid lens 100. In some embodiments, a control device can be provided and electrically connected to the common electrode 124 to, for example, apply and control the first voltage (e.g., common voltage) supplied to the common electrode 124. Similarly, in some embodiments, a control device can be provided and electrically connected to the driving electrode 126 to, for example, apply and control the second voltage (e.g., driving voltage) supplied to the driving electrode 126.

Accordingly, in some embodiments, the bond 135 between the first outer layer 118 and the intermediate layer 120 can be configured to provide electrical continuity across the bond 135 at one or more locations to enable control of the common electrode 124 defined within the sealed cavity 104 based on one or more electrical signals provided (e.g., by a control device) to the conductive layer 128 (e.g., the common electrode 124) defined outside of the sealed cavity 104. Likewise, in some embodiments, the bond 136 between the second outer layer 122 and the intermediate layer 120 can be configured to provide electrical continuity across the bond 136 at one or more locations to enable control of the driving electrode 126 defined within the sealed cavity 104 based on one or more electrical signals provided (e.g., by a control device) to the conductive layer 128 (e.g., the driving electrode 126) defined outside of the sealed cavity 104. Thus, in some embodiments, based at least on the scribe 130 electrically isolating the common electrode 124 and the driving electrode 126, separate and independent electrical signals can be provided (e.g., by one or more control devices) to each of the common electrode 124 and the driving electrode 126 in accordance with embodiments of the disclosure.

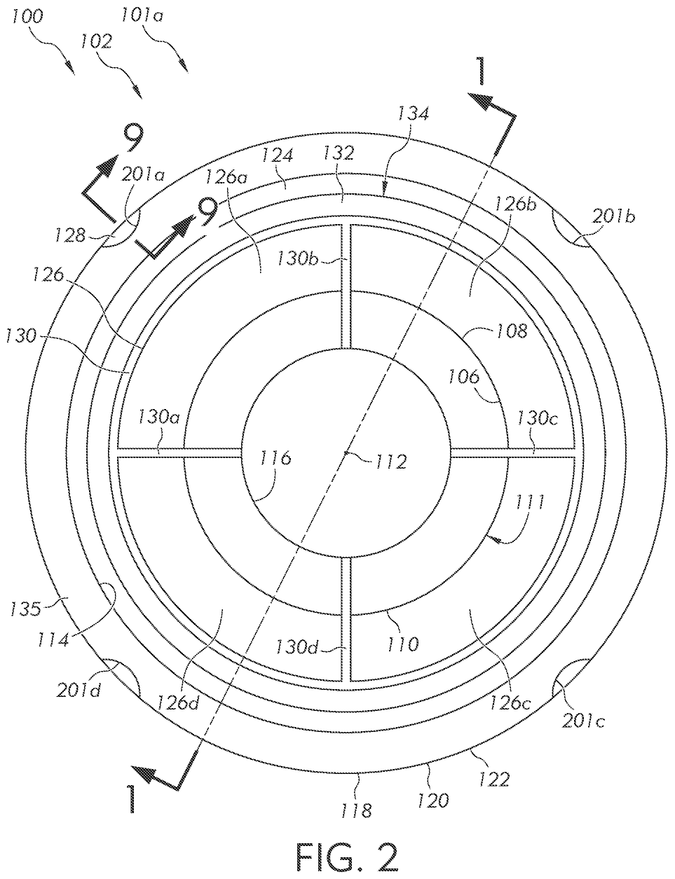

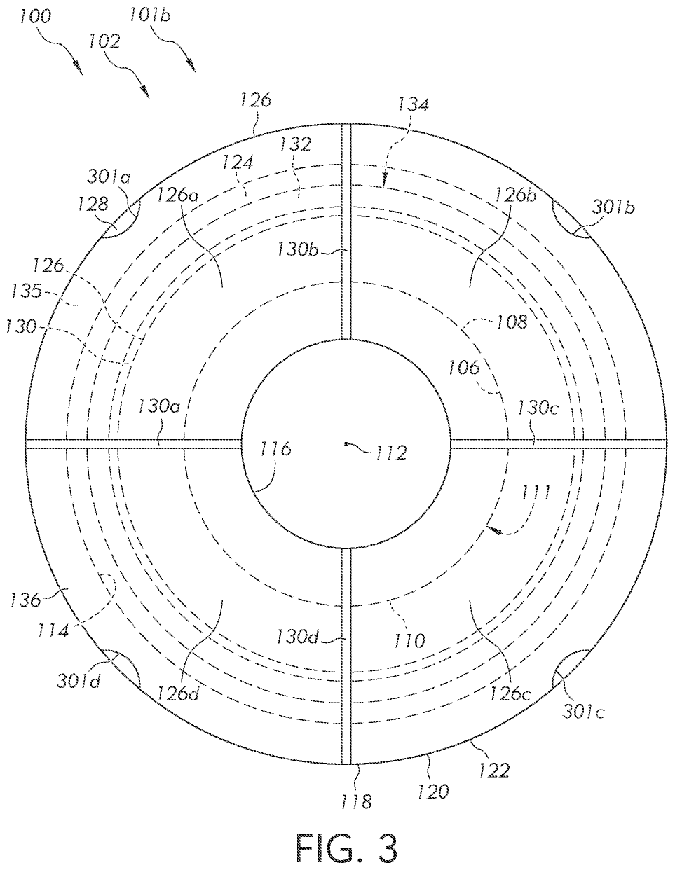

FIG. 2 schematically illustrates a top (e.g., plan) view of the liquid lens 100 taken along line 2-2 of FIG. 1 representing a view facing the first outer layer 118 and looking into the cavity 104 from the object side 101a through the first window 114. Although FIG. 2 illustrates the liquid lens 100 as having a circular perimeter, other embodiments are included in this disclosure. For example, in other embodiments, the perimeter of the liquid lens is triangular, rectangular, elliptical, or another polygonal or non-polygonal shape. Likewise, FIG. 3 schematically illustrates a bottom view of the liquid lens 100 taken along line 3-3 of FIG. 1 representing a view facing the second outer layer 122 and looking into the cavity 104 from the image side 101b through the second window 116. For clarity, in FIG. 2 and FIG. 3, the entire liquid lens 100 is schematically illustrated despite FIG. 1 providing an exemplary cross-sectional view of the liquid lens 100. For example, in some embodiments, FIG. 1 can be understood to show an exemplary cross-sectional view of the liquid lens 100 taken along line 1-1 of FIG. 2 in accordance with embodiments of the disclosure.

As shown in FIG. 2, in some embodiments, the liquid lens 100 can include one or more first cutouts 201a, 201b, 201c, 201d in the first outer layer 118. For example, in some embodiments, four first cutouts 201a, 201b, 201c, 201d can be provided, although more or less first cutouts can be provided in further embodiments without departing form the scope of the disclosure. In some embodiments, the first cutouts 201a, 201b, 201c, 201d can define respective portions of the lens body 102 at which the first outer layer 118 can be removed, machined, or manufactured to expose a corresponding portion of the common electrode 124 of the conductive layer 128. Thus, in some embodiments, the first cutouts 201a, 201b, 201c, 201d can provide electrical contact locations to enable electrical connection of the common electrode 124 to a controller, a driver, or other mechanical, electronic, or electro-mechanical component of a lens or camera system, in accordance with embodiments of the disclosure.

As shown in FIG. 3, in some embodiments, the liquid lens 100 can include one or more second cutouts 301a, 301b, 301c, 301d in the second outer layer 122. For example, in some embodiments, four second cutouts 301a, 301b, 301c, 301d can be provided, although more or less second cutouts can be provided in further embodiments without departing form the scope of the disclosure. In some embodiments, the second cutouts 301a, 301b, 301c, 301d can define respective portions of the lens body 102 at which the second outer layer 122 can be removed, machined, or manufactured to expose a corresponding portion of the driving electrode 126 of the conductive layer 128. Thus, in some embodiments, the second cutouts 301a, 301b, 301c, 301d can provide electrical contact locations to enable electrical connection of the driving electrode 126 to a controller, a driver, or other mechanical, electronic, or electro-mechanical component of a lens or camera system, in accordance with embodiments of the disclosure.

Moreover, as shown in FIG. 2 and FIG. 3, in some embodiments, the driving electrode 126 of the conductive layer 128 can include a plurality of driving electrode segments 126a, 126b, 126c, 126d. In some embodiments, each of the driving electrode segments 126a, 126b, 126c, 126d can be electrically isolated from the common electrode 124 by the scribe 130 and electrically isolated from each other by respective scribes 130a, 130b, 103c, 130d. In some embodiments the scribes 130a, 130b, 103c, 130d can extend from the scribe 130 along the bore 105 of the intermediate layer 120 from the wide end 105b to the narrow end 105a (FIG. 2) and extend underneath the intermediate layer 120 onto a back side of the intermediate layer 120 (FIG. 3). In some embodiments, different driving voltages can be supplied to one or more of the driving electrode segments 126a, 126b, 126c, 126d to tilt the interface 110 of the liquid lens 100 about the optical axis 112, thereby providing, for example, optical image stabilization (OIS) functionality to the liquid lens 100. For example, in some embodiments, based at least on the electrical isolation provided by the scribes 130a, 130b, 130c, 130d in the conductive layer 128, the second cutouts 301a, 301b, 301c, 301d can respectively electrically communicate with each of the driving electrode segments 126a, 126b, 126c, 126d independently and separately to supply different driving voltages to one or more of the driving electrode segments 126a, 126b, 126c, 126d in accordance with embodiments of the disclosure.

In addition or alternatively, in some embodiments, the same driving voltage can be supplied to each driving electrode segment 126a, 126b, 126c, 126d to maintain the interface 110 of the liquid lens 100 in a substantially spherical orientation about the optical axis 112, thereby providing, for example, autofocus functionality to the liquid lens 100. Moreover, although the driving electrode 126 is described as being segmented into four driving electrode segments 126a, 126b, 126c, 126d, in some embodiments, the driving electrode 126 can be divided into two, three, five, six, seven, eight, or more driving electrode segments without departing from the scope of the disclosure. Accordingly, in some embodiments, the number of second cutouts 301a, 301b, 301c, 301d can match the number of driving electrode segments 126a, 126b, 126c, 126d. Likewise, in some embodiments, depending on, for example, the number of driving electrode segments 126a, 126b, 126c, 126d, a corresponding number of scribes 130a, 130b, 130c, 130d can be formed in the conductive layer 128 to electrically isolate each of the driving electrode segments 126a, 126b, 126c, 126d in accordance with embodiments of the disclosure.

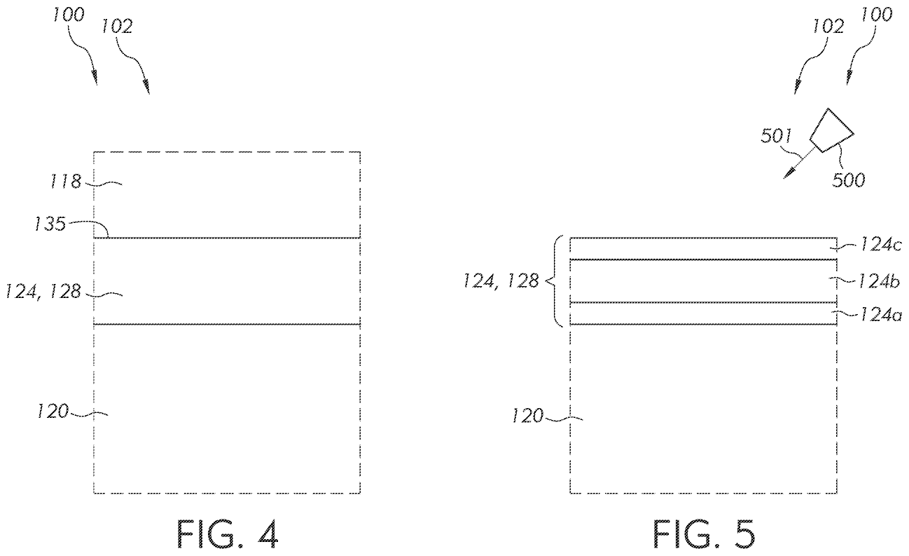

Methods of manufacturing the liquid lens 100 including the bond 135 will now be described with respect to FIGS. 4-8 by way of exemplary embodiments and methods in accordance with the disclosure. For example, FIG. 4 shows an enlarged view of a portion of the liquid lens 100 taken at view 4 of FIG. 1, including the bond 135 to seal (e.g., hermetically seal) the first outer layer 118 and the intermediate layer 120 in accordance with embodiments of the disclosure. Unless otherwise noted, it is to be understood that, in some embodiments, one or more features or methods described with respect to the portion of the liquid lens 100 of FIG. 4 can be provided, either alone or in combination, to provide a bond in accordance with embodiments of the disclosure. For example, in some embodiments, one or more features or methods of the disclosure can provide bond 135 between the first outer layer 118 and the intermediate layer 120, bond 136 between the second outer layer 122 and the intermediate layer 120, or other bond between at least two components, thereby bonding (e.g., sealing, hermetically sealing) the at least two components together.

Likewise, for purposes of the disclosure, unless otherwise noted, it is to be understood that a bond bonding the at least two components together can include or be defined to include one or more materials between the at least two components to, for example, enable bonding, provide electrical conductivity, or other mechanical or functional objectives without departing from the scope of the disclosure. For example, with respect to bond 135 bonding the first outer layer 118 and the intermediate layer 120, in some embodiments, the conductive layer 128 (e.g., common electrode 124) can be provided between the first outer layer 118 and the intermediate layer 120 to, for example, enable bonding and provide electrical conductivity into the cavity 104, without departing from the scope of the disclosure. Accordingly, in some embodiments, bond 135 can include or be defined to include the conductive layer 128 (e.g., common electrode 124) in accordance with embodiments of the disclosure. Moreover, in some embodiments, the bond 135 can be manufactured to define one or more of a variety of shapes and sizes, including shapes and sizes not explicitly disclosed in accordance with embodiments of the disclosure to hermetically seal the lens body 102 without departing from the scope of the disclosure.

FIG. 5 shows an exemplary method of manufacturing the bond 135 of FIG. 4 including applying a conductive material 501 from a conductive material supply device 500 (e.g., nozzle, sprayer, applicator, conductive material source or supply) to the intermediate layer 120 to provide the conductive layer 128 (e.g., the common electrode 124) in accordance with embodiments of the disclosure. In some embodiments, the conductive layer 128 can include a plurality of conductive layers 124a, 124b, 124c that can be applied to the intermediate layer 120 sequentially or simultaneously. As discussed more fully below, in some embodiments each of the plurality of conductive layers 124a, 124b, 124c of the conductive layer 128 can be selected to include material (e.g., material having predetermined material properties) that can obtain advantages with respect to the bond 135 and the methods of bonding.

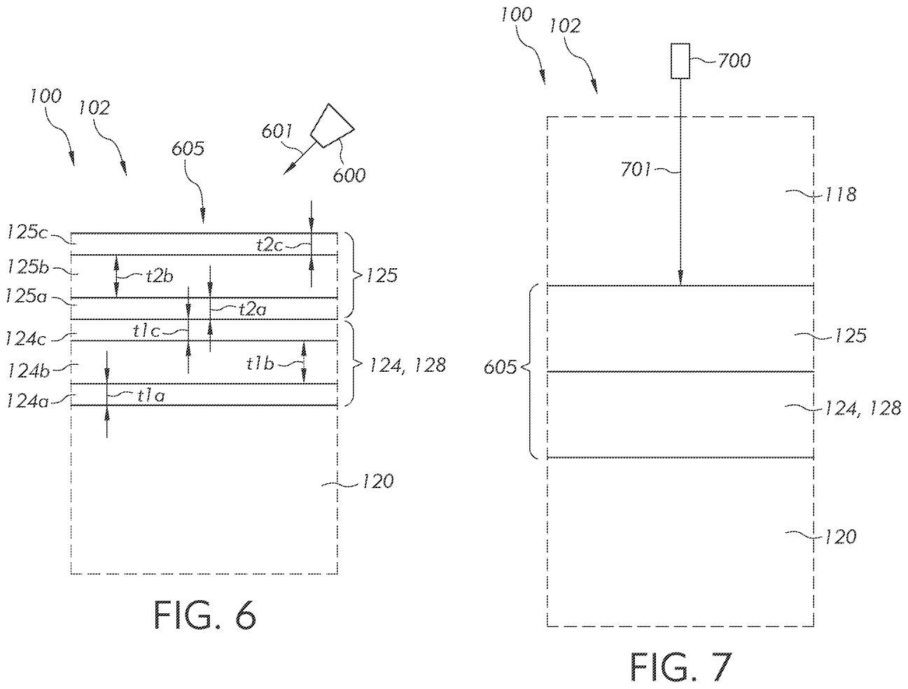

FIG. 6 shows an exemplary method of manufacturing the bond 135 of FIG. 4 including applying an absorber material 601 from an absorber material supply device 600 (e.g., nozzle, sprayer, applicator, absorber material source or supply) to the common electrode 124 of the conductive layer 128 of FIG. 5 to provide an absorber layer 125 (e.g., electromagnetic absorber layer) in accordance with embodiments of the disclosure. In some embodiment at least one of the conductive layer 128 and the absorber layer 125 can define a dark mirror structure 605 (e.g., having the optical properties, such as reflection, described herein). Additionally, in some embodiments, the absorber layer 125 can include a plurality of absorber layers 125a, 125b, 125c that can be applied to the conductive layer 128 sequentially or simultaneously. As discussed more fully below, in some embodiments each of the plurality of absorber layers 125a, 125b, 125c of the absorber layer 125 can be selected to include material (e.g., material having predetermined material properties) providing the dark mirror structure 605 that can obtain advantages with respect to the bond 135 and the methods of bonding.

FIG. 7 shows an exemplary method of manufacturing the bond 135 of FIG. 4 including a method of laser bonding (e.g., laser beam welding) the first outer layer 118 and the intermediate layer 120 by providing a laser beam 701 (e.g., concentrated heat source, ultra-violet laser beam, infrared laser beam) from a laser 700 (e.g., laser device, laser source, ultra-violet laser device, infrared laser device) to heat (e.g., locally heat) the dark mirror structure 605 (e.g., at least the absorber layer 125) of FIG. 6 in accordance with embodiments of the disclosure. For example, the method includes irradiating the dark mirror structure 605 with the laser beam to form the bond 135.

Unless otherwise noted, in some embodiments, features and methods of laser bonding in accordance with embodiments of the disclosure based on the laser 700 and the laser beam 701 can include a device configured to emit light through a process of optical amplification based on the stimulated emission of electromagnetic radiation (e.g., light amplification by stimulated emission of radiation) to produce a narrow, highly concentrated beam of light. For example, in some embodiments, the laser device 700 can operate to generate the laser beam 701 as an intense beam of coherent, monochromatic light or other electromagnetic radiation by stimulated emission of photons from excited atoms or molecules. Thus, in some embodiments, laser bonding in accordance with embodiments of the disclosure can form the bond 135 based at least in part on the narrow, highly concentrated beam of light locally heating and bonding the material of at least two components to be joined (e.g., by melting and/or diffusion of components) to include, for example, a continuous joint defining a hermetically sealed juncture. In some embodiments, laser bonding can provide the lens body 102 as a hermetically sealed package, where contents (e.g., first liquid 106, second liquid 108) contained within the cavity 104 are hermetically sealed within the cavity 104 of the lens body 102.

Additionally, in some embodiments, features of the laser beam 701 of the laser 700 and methods of laser bonding can provide a controlled, focused, concentrated “heat-affected-zone (HAZ). Therefore, in some embodiments, laser bonding can provide the lens body 102 as a hermetically sealed package, where contents (e.g., first liquid 106, second liquid 108) sealed within the cavity 104 can remain as intended during the laser bonding process despite the laser bonding process including features and steps that can heat the bond 135 to temperatures relatively greater than room temperature, that might otherwise disturb or degrade contents (e.g., first liquid 106, second liquid 108) contained within the cavity 104. For example, in some embodiments, features of the laser beam 701 of the laser 700 and methods of laser bonding can provide the lens body 102 as a hermetically sealed package, where contents (e.g., first liquid 106, second liquid 108) sealed within the cavity 104 can remain at room temperature (e.g., undisturbed, from about 20 degrees Celsius to about 30 degrees Celsius, for example about 25 degrees Celsius, or other predetermined temperatures selected to not degrade or disturb the first liquid 106 and the second liquid 108) before, during, and after the laser bonding process.

Moreover, in some embodiments, methods of laser bonding in accordance with embodiments of the disclosure can provide a liquid lens 100 including a hermetically sealed lens body 102 with one or more bonds 135, 136 capable of being employed and operated in a variety of applications for long durations of time (e.g., on the order of 5, 10, 15, 20 or more years) without degradation of the bonds 135, 136, thereby providing the liquid lens 100 including the lens body 102 and the sealed cavity 104 with continuous hermeticity for the long durations of time while being employed and operated in a variety of applications.

In some embodiments, the laser beam 701 can pass through the first outer layer 118 (e.g., based at least on the optical transparency or wavelength transparency of the first outer layer 118 with respect to the wavelength or range of wavelengths of the laser beam 701) and impinge on the absorber layer 125 of the dark mirror structure 605. In some embodiments, the absorber layer 125 can absorb (e.g., as compared to reflect or refract) at least a portion of the laser beam 701, thereby generating thermal energy (e.g., heat). In some embodiments, the thermal energy can locally increase a temperature of the absorber layer 125. Likewise, in some embodiments, the thermal energy can locally increase a temperature of the dark mirror structure 605 (e.g., at least one of the absorber layer 125 and the conductive layer 128). Moreover, in some embodiments, locally increasing a temperature of the dark mirror structure 605, including at least one of the absorber layer 125 and the conductive layer 128, can locally increase a temperature of at least one of the first outer layer 118 and the intermediate layer 120. Additionally, in some embodiments, one or more external forces (not shown) can be applied to the lens body 102 to force (e.g., clamp) the first outer layer 118 and the intermediate layer 120 together while performing one or more steps of the method of laser bonding, in accordance with embodiments of the disclosure, to ensure hermeticity and proper sealing with respect to the bond 135.

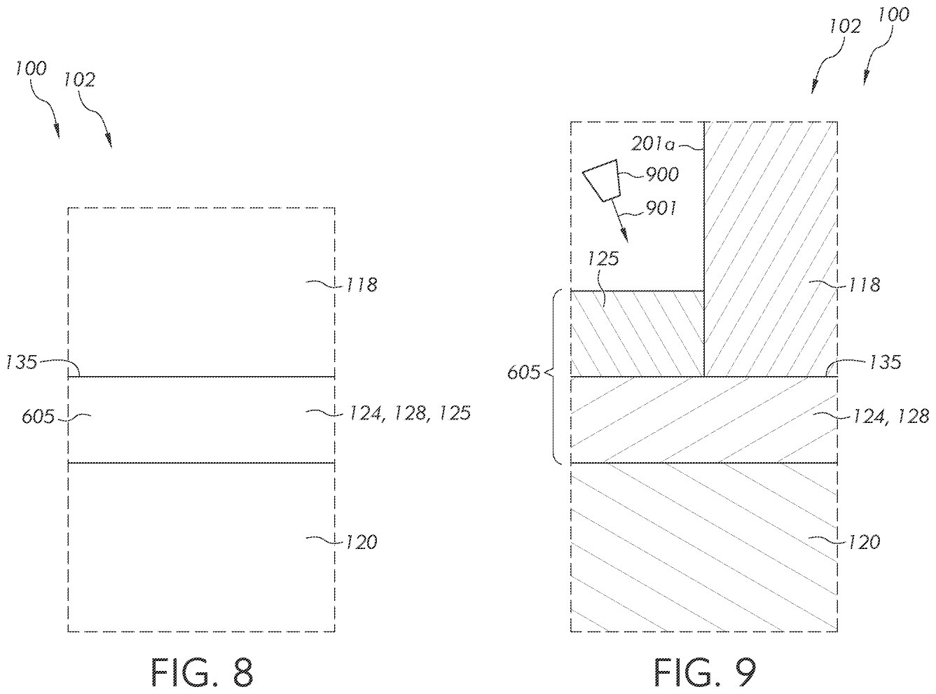

Accordingly, in some embodiments, by increasing the temperature of one or more of the absorber layer 125, the conductive layer 128, the first outer layer 118, and the intermediate layer 120, one or more of the materials defining one or more of the absorber layer 125, the conductive layer 128, the first outer layer 118, and the intermediate layer 120 can bond (e.g., melt, join, unite, combine), thereby forming the bond 135 and sealing (e.g., hermetically sealing) the first outer layer 118 and the intermediate layer 120 based on the bond 135 in accordance with embodiments of the disclosure. For example, FIG. 8 shows an exemplary embodiment of a portion of the liquid lens 100 including the bond 135 manufactured by the exemplary methods of FIGS. 5-7 after the method of laser bonding of FIG. 7 in accordance with embodiments of the disclosure.

In some embodiments, the bond 135, formed by the method of laser bonding of FIG. 7, can include or be defined to include material (e.g., melted, ablated, fused, or otherwise provided directly or indirectly by one or more chemical reactions or phase changes) at least one or more of the absorber layer 125, the conductive layer 128, the first outer layer 118, and the intermediate layer 120. Thus, although schematically illustrated as a line or boundary between the first outer layer 118 and the intermediate layer 120 in FIG. 8, unless otherwise noted, it is to be understood that, in some embodiments, the bond 135 can include or be defined to include material (e.g., melted, ablated, fused, or otherwise provided directly or indirectly by one or more chemical reactions or phase changes) at least one or more of the absorber layer 125, the conductive layer 128, the first outer layer 118, and the intermediate layer 120, as well as a non-zero thickness defining a hermetically sealed, seamless juncture joining the first outer layer 118 and the intermediate layer 120 in accordance with embodiments of the disclosure, without departing from the scope of the disclosure.

Moreover, in some embodiments, the bond 135 manufactured by the exemplary methods of FIGS. 5-7 and schematically illustrated in the exemplary embodiment of the portion of the liquid lens 100 of FIG. 8 can correspond to the portion of the liquid lens 100 taken at view 4 of FIG. 1 and, therefore, be employed with respect to the liquid lens 100 of FIGS. 1-3 as disclosed in accordance with embodiments of the disclosure.

FIG. 9 shows an exemplary method of manufacturing an electrical contact taken at cross-sectional view 9-9 of FIG. 2 of the cutout 201a including a method of applying an etchant 901 from an etchant supply device 900 (e.g., nozzle, sprayer, applicator, etchant source or supply) to the absorber layer 125 of the dark mirror structure 605 of FIG. 6 in accordance with embodiments of the disclosure. For example, in some embodiments, applying the etchant 901 to the absorber layer 125 can remove (e.g., based at least in part on a chemical reaction between the etchant 901 and the absorber layer 125) the absorber layer 125 from the conductive layer 128, thereby exposing the conductive layer (e.g., common electrode 124) to provide electrical contacts at the cutout 201a.

In some embodiments, the dark mirror structure 605 can include material (e.g., material having predetermined material properties) that can enable advantages with respect to the etchant 901 and the methods of etching. For example, in some embodiments, one or more of the materials of the conductive layer 128, the absorber layer 125, and/or the etchant 901, as well as the methods of applying one or more of the materials of the conductive layer 128, the absorber layer 125, and/or the etchant 901 can either directly or indirectly (e.g., based on a chemical reaction) include material (e.g., material having predetermined material properties), that can enable advantages with respect to the bond 135 and the methods of bonding as well as providing conductive pads at one or more of the first cutouts 201a, 201b, 201c, 201d in the first outer layer 118 and the second cutouts 301a, 301b, 301c, 301d in the second outer layer 122 for electrical contact and electrical connection in accordance with embodiments of the disclosure.

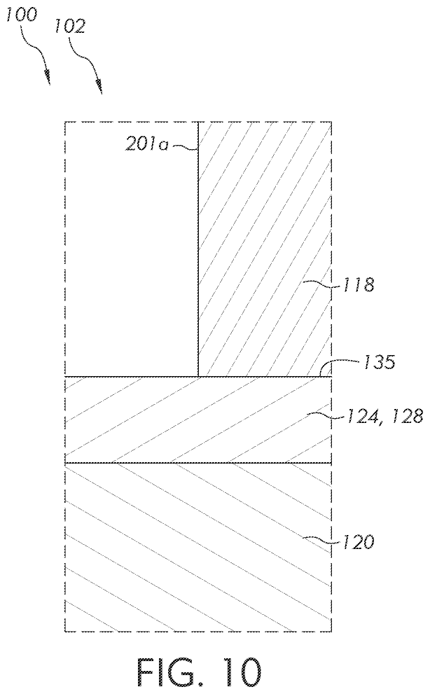

Moreover, in some embodiments, the electrical contact at cutout 201a manufactured by the exemplary methods of etching of FIG. 9 and schematically illustrated in the exemplary embodiment of the portion of the liquid lens 100 of FIG. 9 and FIG. 10 corresponding to a portion of the liquid lens 100 taken at view 9-9 of FIG. 2 can be employed with respect to the liquid lens 100 of FIGS. 1-3 and the first cutouts 201a, 201b, 201c, 201d in the first outer layer 118 and the second cutouts 301a, 301b, 301c, 301d in the second outer layer 122, as disclosed in accordance with embodiments of the disclosure.

In some embodiments, the profile of the bore 105 of the intermediate layer 120 including the orientation or inclination of the sidewalls including the exposed surface 133 of the insulative layer 132 as well as the surface energies of the first liquid 106, the second liquid 108, and the insulative layer 132 can define the shape (e.g., curvature) of the interface 110. Additionally, in some embodiments, the shape of the interface 110 can be modulated by application of voltage to the common electrode 124 and the driving electrode 126 of the conductive layer 128 based on the principle of electrowetting as set forth above.

Moreover, it can be appreciated that a challenge to manufacturing an electrowetting device such as the liquid lens 100 of the present disclosure can include forming a hermetic seal (e.g., first bond 135, second bond 136) between the first outer layer 118, the intermediate layer 120, and the second outer layer 122. For example, in some embodiments, the hermetic seal can be formed at less than about 100 degrees Celsius (e.g., without heating the liquids 106, 108 and/or the insulative layer 132 above about 100 degrees Celsius). The ability to form the hermetic seal without heating organic components of the liquid lens can be beneficial because, as noted, the laser bonding can be performed after deposition of the insulative layer 132 and after filling the cavity 104 with the liquids 106, 108. Additionally, in some embodiments, adhesives may be unable to bond wet surfaces and may be unable to form a durable hermetic seal sufficient for operation of the liquid lens 100 as employed in a variety of devices and applications. Likewise, in some embodiments, metal to metal bonding or frit bonding may be performed at temperatures unsuitable for the liquids 106, 108 and the insulative layer 132.

Thus, in some embodiments, methods of bonding in accordance with embodiments of the disclosure based on laser beam welding can hermetically bond glass material to glass material (e.g., first outer layer 118, intermediate layer 120, and second outer layer 122) and/or glass material (e.g., first outer layer 118, intermediate layer 120, and second outer layer 122) to metal material (e.g., conductive layer 128) at about room temperature and in wet environments. In some embodiments, laser beam welding of transparent glass materials employs a laser beam 701 wavelength to which the glass material (e.g., first outer layer 118, intermediate layer 120, and second outer layer 122) is transparent. Likewise, the absorber layer 125 can be provided at the interface to be bonded (e.g., bond 135, 136) and can be non-transparent to the wavelength of the laser beam 701 such that the absorber layer 125 can absorb the focused laser light, thereby causing rapid localized heating. In some embodiments, laser sources 700 that produce a laser beam 701 including wavelengths defined as approximately ultra-violet (e.g., 100 nanometers to 400 nanometers) can provide concentrated, localized heating, thereby reducing and/or preventing degradation of the liquids 106, 108 and the insulative layer 132, as well as high transmission in (e.g., through) the glass material (e.g., first outer layer 118, intermediate layer 120, and second outer layer 122) in accordance with embodiments of the disclosure.

Additionally, in some embodiments, considerations with respect to operation of the electrowetting device (e.g., liquid lens 100) can affect one or more features of the conductive layer 128. For example, in some embodiments, without an absorber layer 125, the conductive layer 128 would functionally serve as an absorber for laser beam welding at, for example, ultra-violet wavelengths (e.g., 100 nanometers to 400 nanometers). Additionally, in some embodiments, the conductive layer 128 may include low reflectivity at visible wavelengths (e.g., about 390 nanometers to 700 nanometers) to suppress stray optical reflections within the bore 105 of the intermediate layer 120 as the conductive layer 128 can define, for example, an optical aperture. Moreover, because electrowetting can be a voltage driven phenomenon, in some embodiments, resistance of the conductive layer 128 may not be low, as the conductive layer 128 may not be exposed to large current flows.

Additionally, in some embodiments, the first cutouts 201a, 201b, 201c, 201d in the first outer layer 118 and the second cutouts 301a, 301b, 301c, 301d in the second outer layer 122 can be employed as electrical contacts (e.g., connections) upon integration of the liquid lens 100 into one or more electronic devices. Thus, in some embodiments the conductive layer 128 may be suitable for wire bonding, soldering, electrical conductive adhesive bonding, or conductive epoxy bonding, for example, after singulation. Likewise, in some embodiments, the liquid lens 100 can be employed in a variety of environments subjecting one or more components of the liquid lens 100 to a variety of conditions including but not limited to, hot and cold temperatures, moisture, moisture in combination with voltages of up to 75V as well as other harsh or complex environmental conditions encountered, for example, in one or more consumer applications.

Accordingly, in some embodiments, characteristics of the dark mirror structure 605 including the conductive layer 128 including the plurality of conductive layers 124a, 124b, 124c, and the absorber layer 125 including the plurality of absorber layers 125a, 125b, 125c, as well as characteristics of the insulative layer 132, the bond 135, and the lens body 102 can achieve such diverse considerations in accordance with embodiments of the disclosure.

Without intending to be bound by theory, some observations with respect to characteristics of the liquid lens 100 can, therefore, be defined. In some embodiments, metals can be highly reflective and, therefore, be unsuitable as an absorber and unsuitable to provide low reflectivity as an optical aperture. Thus, in some embodiments, a dark mirror structure 605 can be provided by depositing a lossy dielectric (e.g., absorber layer 125) over reflective metal (e.g., conductive layer 128). In some embodiments, the absorber layer 125 can include black chrome consisting of a CrOx or CrON coating. Additionally, in some embodiments, the conductive layer 128 can include a chrome metal, which can serve as an optical aperture for optical elements. Unless otherwise noted, in some embodiments, for example, when employing the liquid lens as a single cavity optical element, such designs may provide high ultra-violet reflectivity to achieve a low reflectivity in the visible wavelength range over a wide range of viewing angles. Thus, as but one example, in some embodiments, a chrome coating for optical devices can exhibit a reflectivity minimum of 1% or less at a wavelength in the range of 550 nanometers to 620 nanometers (e.g., within the visible wavelength spectrum) and a reflectivity of 25%-35% at a wavelength of 355 nanometers (e.g., within the ultra-violet wavelength spectrum).

In some embodiments, features and methods of the disclosure can enable a dark mirror structure 605 (e.g., at least one of the absorber layer 125 and the conductive layer 128) exhibiting a reflectivity of less than or equal to 25%, for example, less than or equal to 10%, at an ultra-violet wavelength within the ultra-violet wavelength spectrum, while maintaining a reflectivity minimum of 1% or less at a visible wavelength in the visible wavelength spectrum. Accordingly, in some embodiments, features and methods of the disclosure can provide a wider process window with respect to methods of laser beam welding as compared to typical or conventional features and methods not employing features and methods of the disclosure.

Additionally, in some embodiments, formation of electrical contacts (e.g., the first cutouts 201a, 201b, 201c, 201d in the first outer layer 118 and the second cutouts 301a, 301b, 301c, 301d in the second outer layer 122) at the periphery of the liquid lens 100 can present further consideration with respect to the materials of at least one or more of the absorber layer 125, the conductive layer 128, the first outer layer 118, and the intermediate layer 120 as well as methods of bonding. For example, in some embodiments, properties or characteristics with respect to the etchant 901 (FIG. 9) employed to remove the absorber layer 125 and expose the conductive layer 128 to provide electrical contacts (e.g., the first cutouts 201a, 201b, 201c, 201d in the first outer layer 118 and the second cutouts 301a, 301b, 301c, 301d in the second outer layer 122).

For example, in some embodiments, CrON or CrOx (e.g., absorber layer 125) can be insulating and, therefore, may be removed to provide electrical contact with the conductive layer 128. However, in some embodiments, removal of the CrON from a Cr/CrON dark mirror can be challenging because, for example, both materials can be soluble in a chrome etchant (e.g., a cerium ammonium nitrate-based etchant such as Transene 1020 or 1020AC). Thus, in some embodiments, a thin chrome layer left after etching can be unsuitable for robust electrical contact. Rather a relatively thicker mechanically strong pad may, therefore, be deposited on top of the thin film metal to provide a reliable electrical connection. However, in some embodiments, geometry of the lens body 102 of the liquid lens 100, for example, after bonding the first outer layer 118, the intermediate layer 120, and the second outer layer 122, may not be well suited for electrolytic plating as there may not be a simple electrical contact for the plating or for an electrical path to all the pads. Thus, in some embodiments, electroless plating chemistry can be employed to form electrical contacts (e.g., the first cutouts 201a, 201b, 201c, 201d in the first outer layer 118 and the second cutouts 301a, 301b, 301c, 301d in the second outer layer 122) at the periphery of the liquid lens 100.

Moreover, in some embodiments, electromigration failure of Cr/CrON electrodes under conditions of damp heat while driven at operational voltages may occur. Without intending to be bound by theory, one would not expect an electromigration failure in a voltage driven device; however, it is believed that, in some embodiments, moisture condensation can create a short over which current can flow. In some embodiments, such an electromigration failure mode was not observed with a Cu electrode including a Ti adhesion layer. However, Cu can be highly soluble in CrON etchant, so an etch stop layer can be deposited between Cu and CrON to make a dark mirror structure (e.g., dark mirror structure 605). Thus, without intending to be bound by theory, a dark mirror structure of a Ti adhesion layer, Cu electrode, Ti etch stop, and CrON absorber layer may be able to satisfy the various process parameters of the electrode stack. However, in some of such embodiments, etching the CrON absorber layer to expose the metallization for pad buildup was found to lead to complete failure of the electrode stack as the CrON layer was etching slowly, thereby giving opportunity for etchant to form pinholes in the etch stop and leading to rapid undercutting and failure of the electrode.

Accordingly, in some embodiments, features and methods of the disclosure can provide electrode structures (e.g., conductive layer 128), a CrON composition range (e.g., absorber layer 125), and deposition processes which create a dark mirror structure 605 suitable for a wafer based electrowetting device manufactured on wafer scale employing a glass first outer layer 118, a glass intermediate layer 120, and a glass second outer layer 122. In some embodiments, the dark mirror structure 605 can be formed on a Ti/Cu/Ti metallization stack (e.g., defining conductive layer 128, including the plurality of conductive layers 124a, 124b, 124c) with one or more layers of Cr, CrON, and CrOx (e.g., defining absorber layer 125, including the plurality of absorber layers 125a, 125b, 125c), as shown in FIG. 5 and FIG. 6). Additionally, in some embodiments, the CrON layer and its constituent layers can be readily etched from the underlying metal in Transene 1020 etchant in less than 10 sec at 30° C. to, for example, provide electrical contacts (e.g., the first cutouts 201a, 201b, 201c, 201d in the first outer layer 118 and the second cutouts 301a, 301b, 301c, 301d in the second outer layer 122) at the periphery of the liquid lens 100, as shown in FIG. 9 and FIG. 10. In some embodiments, a CrON composition range and deposition processes produce a dark mirror coating with reduced etch time in Transene 1020 etchant at 30° C. from 45 sec to less than 10 sec, for example, less than 5 sec, thereby permitting pad formation without degradation of the underlying metallization.

Moreover, in some embodiments, features and methods of the disclosure can provide a dark mirror structure 605 with reflectivity minimum less than 1% in the wavelength range of 550 nm to 620 nm, thereby reducing stray light reflection in the optical aperture defining optical lens attributes for optical lens applications, as shown in FIGS. 1-3. Likewise, in some embodiments, features and methods of the disclosure can provide a dark mirror structure 605 with a 355 nm reflectivity of less than 25%, for example, less than 10% (e.g., with respect to a three layer coating), which can provide advantageous features with respect to laser beam welding, as shown in FIG. 7 and FIG. 8, as well as optical lens attributes for optical lens applications, as shown in FIGS. 1-3. For example, in some embodiments, features and methods of the disclosure can provide a dark mirror structure 605 widening the process window with respect to laser beam welding in accordance with embodiments of the disclosure.

### EXPERIMENTAL

Experimental data was obtained, in accordance with embodiments of the disclosure. For example, a conductive layer 128 with conductive layers 124a, 124b, 124c of 10 nanometer (nm) Ti/100 nm Cu/30 nm Ti was deposited by sputtering on 150 millimeters (mm) diameter semi-standard wafers (e.g., intermediate layer 120) of Eagle XG (EXG) Glass using an Applied Materials Centura PVD (e.g., conductive material 501 from conductive material supply device 500, FIG. 5). Additionally, Cr, CrON, and Cr2O3 films (e.g., absorber layers 125a, 125b, 125c of absorber layer 125) were deposited by reactive sputtering on the Ti/Cu/Ti coated 150 mm EXG Glass (e.g., intermediate layer 120) using an AJA Orion confocal sputter tool using a 3″ Cr target (Kurt J. Lesker Co.) (e.g., absorber material 601 from absorber material supply device 600, FIG. 6) to provide a dark mirror structure 605. Optical reflectance of the Cr, CrON, and Cr2O3 films (e.g., absorber layer 125) were measured using a Filmetrics F50XY over the wavelength range of 190 nanometers to 1700 nanometers. Thickness and optical dispersions were fitted from spectroscopic ellipsometry performed using a Woollam M2000 and simulations performed using Woollam CompleteEase using a Tauc-Lorentz or Cody-Lorentz model, as appropriate. Thin film simulations were performed using TFCalc using the optical dispersions obtained from spectroscopic ellipsometry. Additionally, CrON etching of the films was performed in a beaker of Transene 1020 etchant (e.g., etchant 901 from etchant supply device 900, FIG. 9) at the temperature of interest (23° C. or 30° C.) to simulate creation of the electrical contacts at, for example, the first cutouts 201a, 201b, 201c, 201d in the first outer layer 118 and the second cutouts 301a, 301b, 301c, 301d in the second outer layer 122, in accordance with embodiments of the disclosure. Moreover, composition of the films (e.g., absorber layer 125) was measured by XPS.

### Example 1

With respect to the parameters set forth in TABLE 1, a large CrON process space was mapped in a Box-Behnken experiment in the AJA Orion varying total gas flow rate (40 to 80 sccm), fraction of oxygen in gas stream (3 to 12%), fraction of nitrogen in the gas stream (0 to 35%), and pressure (6 to 20 mtorr) while keeping DC power applied to gun constant at 400 W, deposition time constant at 300 sec, and confocal geometry constant (32 mm height on sample stage, 6 mm tilt to gun).

TABLE 1

| | | | | | Etch Rate | Ln | |
|---|---|---|---|---|---|---|---|
| | | | | Pr | 1020 | Etch | Sim. |
| Run | Flow | Fr O2 | Fr N2 | (mT) | (nm/s) | Rate | R620 |
| 1 | 60 | 0.12 | 0.175 | 20 | 0.02 | −3.76 | 13.704 |
| 2 | 60 | 0.03 | 0.175 | 6 | 4.61 | 1.53 | 0.531 |
| 3 | 60 | 0.075 | 0.35 | 6 | 11.86 | 2.47 | 16.534 |
| 4 | 60 | 0.075 | 0.175 | 13 | 13.00 | 2.57 | 14.958 |
| 5 | 40 | 0.075 | 0 | 13 | 0.88 | −0.13 | 5.211 |
| 6 | 80 | 0.03 | 0.175 | 13 | 21.07 | 3.05 | 6.621 |
| 7 | 40 | 0.03 | 0.175 | 13 | 18.89 | 2.94 | 0.061 |
| 8 | 60 | 0.12 | 0 | 13 | 5.60 | 1.72 | 25.499 |
| 9 | 40 | 0.075 | 0.175 | 6 | 9.88 | 2.29 | 5.953 |
| 10 | 60 | 0.075 | 0.175 | 13 | 0.59 | −0.53 | 14.958 |
| 11 | 60 | 0.03 | 0 | 13 | 3.79 | 1.33 | 0.475 |
| 12 | 60 | 0.12 | 0.175 | 6 | 17.60 | 2.87 | 23.062 |
| 13 | 40 | 0.075 | 0.175 | 20 | 16.32 | 2.79 | 16.012 |
| 14 | 80 | 0.075 | 0.35 | 13 | 2.56 | 0.94 | 25.405 |
| 15 | 80 | 0.075 | 0.175 | 6 | 9.54 | 2.26 | 13.976 |
| 16 | 60 | 0.03 | 0.33 | 13 | 17.54 | 2.86 | 12.128 |
| 17 | 80 | 0.075 | 0 | 13 | 14.95 | 2.70 | 12.443 |
| 18 | 40 | 0.075 | 0.35 | 13 | 7.37 | 2.00 | 17.611 |
| 19 | 60 | 0.03 | 0.175 | 20 | 13.43 | 2.60 | 6.194 |
| 20 | 80 | 0.075 | 0.175 | 20 | 0.02 | −4.01 | 25.044 |
| 21 | 60 | 0.12 | 0.35 | 13 | 0.05 | −2.93 | 9.077 |
| 22 | 60 | 0.075 | 0.35 | 20 | 0.05 | −3.00 | 24.485 |
| 23 | 40 | 0.12 | 0.175 | 13 | 0.38 | −0.98 | 24.518 |
| 24 | 60 | 0.075 | 0 | 20 | 8.31 | 2.12 | 13.479 |
| 25 | 60 | 0.075 | 0 | 6 | 10.97 | 2.40 | 4.664 |
| 26 | 60 | 0.075 | 0.175 | 13 | 22.64 | 3.12 | 14.958 |
| 27 | 80 | 0.12 | 0.175 | 13 | 0.02 | −3.97 | 10.791 |

Films were deposited on Ti/Cu/Ti coated EXG Glass and characterized by measuring reflectance spectra, thickness, and optical dispersion by spectroscopic ellipsometry, and etch time in Transene 1020 chrome etchant at 23° C. TFCalc was used to simulate a dark mirror film stack having the calculated optical dispersions for each condition to determine the lowest possible minimum reflectivity at 620 nm. The impact of the process variables upon the etch time and minimum reflectivity were then fit using JMP to the Box-Behnken experiment. The 620 nm minimum reflectivity was positively correlated with both the oxygen and nitrogen fraction of the gas stream. Etch time was positively correlated with oxygen fraction and pressure. From this experiment, without intending to be bound by theory, it can be observed, that a favorable process space to create a fast etching, low reflectivity, dark mirror can employ lower oxygen and nitrogen fraction and moderate pressure.

### Example 2

With respect to the parameters set forth in TABLE 2, the smaller CrON process space suggested by the experiment in EXAMPLE 1 was mapped in a second Box-Behnken experiment varying pressure (13 to 19 mtorr), gas flow (40 to 80 sccm), oxygen fraction of gas flow (2 to 6%), and nitrogen fraction of gas flow (0 to 17.5%). Fixed were deposition time of 120 sec, DC power of 400 W, and confocal geometry constant (32 mm height on sample stage, 6 mm tilt to gun).

TABLE 2

| | | | | | Etch | | | Ellipsometry | | | | | |
|---|---|---|---|---|---|---|---|---|---|---|---|---|---|
| | Process variables | | | | 1020 | log | | | th | | | Simulation | |
| Run | Ar | N2 | O2 | Pr | etch | (1020ET) | FOM | MSE | (nm) | n550 | k550 | th_620 | Rmin620 |
| 1 | 57.6 | 0 | 2.4 | 13 | 11 | 1.041 | 9.56 | 5.214 | 58.69 | 2.450 | 0.797 | 24.50 | 9.18 |
| 2 | 51.15 | 5.25 | 3.6 | 13 | 30 | 1.477 | 1.18 | 19.21 | 79.19 | 2.009 | 0.030 | 58.00 | 0.80 |
| 3 | 48.3 | 10.5 | 1.2 | 16 | 5 | 0.699 | 9.31 | 5.35 | 60.41 | 2.107 | 0.935 | 59.00 | 13.32 |
| 4 | 52.35 | 5.25 | 2.4 | 16 | 7 | 0.845 | 1.00 | 44.75 | 60.79 | 2.123 | 0.200 | 54.00 | 1.18 |
| 5 | 38.4 | 0 | 1.6 | 16 | 180 | 2.255 | 32.09 | 5.19 | 53.15 | 2.374 | 1.025 | 36.50 | 14.23 |
| 6 | 35.7 | 3.5 | 0.8 | 16 | 16 | 1.204 | 19.18 | 3.44 | 44.83 | 2.430 | 1.083 | 35.70 | 15.93 |
| 7 | 51.15 | 5.25 | 3.6 | 19 | 3 | 0.477 | 2.05 | 27.78 | 65.19 | 3.953 | 0.117 | 61.50 | 4.30 |
| 8 | 34.9 | 3.5 | 1.6 | 19 | 11 | 1.041 | 9.17 | 4 | 49.09 | 2.315 | 0.784 | 42.00 | 8.81 |
| 9 | 31.4 | 7 | 1.6 | 16 | 7 | 0.845 | 2.11 | 9.75 | 33.49 | 2.043 | 0.526 | 55.00 | 2.50 |
| 10 | 69.8 | 7 | 3.2 | 13 | 6 | 0.778 | 2.23 | 27.88 | 79.97 | 2.019 | 0.130 | 57.30 | 2.86 |
| 11 | 58.8 | 0 | 1.2 | 16 | 19 | 1.279 | 18.68 | 5.19 | 53.15 | 2.977 | 1.024 | 35.00 | 14.61 |
| 12 | 45.9 | 10.5 | 3.6 | 16 | 4 | 0.602 | 2.18 | 27.56 | 60.33 | 1.958 | 0.127 | 60.70 | 3.62 |
| 13 | 47.1 | 10.5 | 2.4 | 19 | 4 | 0.602 | 2.47 | 22 | 53.22 | 1.995 | 0.107 | 58.70 | 4.11 |
| 14 | 52.35 | 5.25 | 2.4 | 16 | 11 | 1.041 | 1.15 | 41 | 56.65 | 2.195 | 0.170 | 50.00 | 3.30 |
| 15 | 69.8 | 7 | 3.2 | 19 | 4 | 0.602 | 2.17 | 37.2 | 62.9 | 1.995 | 0.116 | 58.40 | 3.60 |
| 16 | 53.55 | 5.25 | 1.2 | 13 | 15 | 1.176 | 21.04 | 3.35 | 83.18 | 2.048 | 1.097 | 64.00 | 17.89 |
| 17 | 57.6 | 0 | 2.4 | 19 | 8 | 0.903 | 1.77 | 32.21 | 47.19 | 2.390 | 0.465 | 40.70 | 1.96 |
| 18 | 47.1 | 10.5 | 2.4 | 13 | 5 | 0.699 | 2.25 | 24.3 | 58.86 | 2.157 | 0.095 | 51.30 | 3.22 |
| 19 | 56.4 | 0 | 3.6 | 16 | 7 | 0.845 | 3.01 | 41.79 | 82.89 | 1.984 | 0.119 | 59.00 | 3.56 |
| 20 | 76.8 | 0 | 3.2 | 16 | 9 | 0.954 | 1.71 | 33.65 | 74.72 | 2.128 | 0.136 | 52.00 | 1.79 |
| 21 | 71.4 | 7 | 1.6 | 16 | 10 | 1.000 | 9.62 | 3.79 | 46.97 | 2.432 | 0.808 | 38.00 | 9.62 |
| 22 | 62.8 | 14 | 3.2 | 16 | 3 | 0.477 | 1.78 | 24.97 | 59.02 | 1.990 | 0.118 | 59.20 | 3.74 |
| 23 | 52.35 | 15.25 | 2.4 | 16 | 8 | 0.909 | 0.95 | 20.6 | 52.89 | 2.348 | 0.141 | 44.50 | 1.05 |
| 24 | 34.1 | 3.5 | 2.4 | 16 | 8 | 0.903 | 0.93 | 24.1 | 53.34 | 2.354 | 0.137 | 44.00 | 1.03 |
| 25 | 34.9 | 3.5 | 1.6 | 13 | 20 | 1.301 | 18.47 | 3.16 | 55.43 | 2.386 | 1.011 | 37.00 | 14.20 |
| 26 | 53.55 | 5.25 | 1.2 | 19 | 75 | 1.875 | 18.66 | 4.53 | 193.5 | 2.043 | 0.863 | 56 | 9.95 |
| 27 | 68.2 | 7 | 4.8 | 16 | 8 | 0.903 | 4.89 | 26.62 | 65 | 2.030 | 0.079 | 57.40 | 5.41 |

Films were deposited on Ti/Cu/Ti coated EXG Glass and characterized by measuring reflectance spectra, thickness, optical dispersion by spectroscopic ellipsometry, and etch time in Transene 1020 chrome etchant at 23° C. TFCalc was used to simulate a dark mirror film stack having the calculated optical dispersions for each condition to determine the lowest possible minimum reflectivity at 620 nm. A figure of merit (FOM) was calculated as minimum 620 nm reflectivity×log(etch time). The impact of the process variables upon the etch time, minimum reflectivity, and FOM were then fit using JMP to the Box-Behnken experiment. The minimum reflectance was inversely correlated with oxygen flow and gas flow. Additionally, the log of etch time was seen to be inversely correlated with oxygen and nitrogen fraction in the gas stream.

Comparing the results of EXAMPLE 1 and EXAMPLE 2, without intending to be bound by theory, it can be observed that partially oxidized CrON etched fastest while fully oxidized or metallic chrome etched slower. The FOM was negatively correlated with oxygen fraction and gas flow, and positively correlated with nitrogen fraction. Best uniformity was obtained with 4% O2 and 8.7% N2, 55 sccm total flow, 16 mT pressure, 400 W DC, and the 32 mm/6 mm confocal geometry parameters described above. This process was used in EXAMPLE 4.

### Example 3

With respect to the parameters set forth in TABLE 3, a third experiment mapped the process space defined by EXAMPLE 1 and EXAMPLE 2 into composition space using a central composite design. Process variables were fraction oxygen (2 to 6%) and nitrogen (0 to 17.5%) while total gas flow was fixed at 60 sccm. Additionally, fixed were deposition time of 300 sec, DC power of 400 W, and confocal geometry constant (32 mm height on sample stage, 6 mm tilt to gun).

TABLE 3

| | | | | | | | | 1020 | | |
|---|---|---|---|---|---|---|---|---|---|---|
| Run | Ar | O2 | N2 | Pr | Cr | N | O | ET | Rmin | R355 |
| 1 | 47.1 | 2.4 | 10.5 | 16 | 43.7 | 1.80 | 54.9 | 3 | 6.07 | 24.75 |
| 2 | 57.6 | 2.4 | 0 | 16 | 52.1 | 0.00 | 47.9 | 8 | 4.96 | 14.48 |
| 3 | 45.9 | 3.6 | 10.5 | 16 | 42.1 | 1.05 | 56.8 | 3 | 4.3 | 26.79 |
| 4 | 48.3 | 1.2 | 10.5 | 16 | 50.9 | 14.6 | 34.0 | 5 | 13.32 | 18.4 |
| 5 | 58.8 | 1.2 | 0 | 16 | 60.31 | 0.00 | 39.69 | 19 | 14.61 | 16.75 |
| 6 | 51.15 | 3.6 | 5.25 | 16 | 43.8 | 1.40 | 54.8 | 4 | 1.79 | 20.75 |
| 7 | 52.35 | 2.4 | 5.25 | 16 | 43.16 | 1.72 | 55.11 | 7 | 1.18 | 21.57 |
| 8 | 53.55 | 1.2 | 5.25 | 16 | 58.7 | 8.80 | 31.9 | 14 | 10.44 | 16.80 |
| 9 | 52.35 | 2.4 | 5.25 | 16 | 42.8 | 1.41 | 55.8 | 5 | 5.45 | 23.59 |
| 10 | 56.4 | 3.6 | 0 | 16 | 42.6 | 0.00 | 57.4 | 7 | 3.56 | 28.6 |

Substrates were Ti/Cu/Ti coated EXG Glass. Reflectivity, thickness, optical dispersion, and composition were measured. The measured optical dispersions were used to simulate dark mirrors, and a second set of samples on Ti/Cu/Ti coated EXG Glass was deposited to create dark mirror structures with thickness appropriate for placing the reflectance minimum in 580 nm to 640 nm wavelength range. The second set of samples was characterized for etch time in Transene 1020 at 30° C., reflectance in the visible wavelength range, and reflectance at 355 nm. Composition was measured by XPS, etch time, minimum visible reflectance, and 355 nm reflectance, and the FOM were fit for the central composite design using JMP. Oxygen in the gas stream was seen to be far more reactive than nitrogen. Oxygen content in the film depended on oxygen fraction while nitrogen content was diminished strongly by oxygen in the gas stream. Etch time was inversely correlated with oxygen and nitrogen fraction in the gas stream, and positively correlated with chrome content in the film. Minimum visible reflectance was primarily dependent on oxygen fraction in gas stream or oxygen content of the film. FOM was negatively correlated with oxygen and nitrogen in the gas stream and positively correlated with chrome content in the film, while UV reflectance at 355 nm was lowest in metallic films and highest in transparent dielectrics. Thus, without intending to be bound by theory, it can be observed that 355 nm reflectivity, visible reflectivity, and etch times were not minimized simultaneously using a single layer dark mirror Ti/Cu/Ti/CrON design.

### Example 4

In a fourth experiment, designs defined to reduce 355 nm reflectance while maintaining low visible reflectance and low etch times in Transene 1020 chrome etchants were investigated. From the results of EXAMPLES 1-3 and preliminary simulations, three film compositions were considered for inclusion in the layer stacks. The best performing CrON composition in EXAMPLE 2 was labeled as CrON in the following example. Thin layers of chrome metal were also considered as simulations and revealed the minimum reflectance of a single layer dark mirror was strongly dependent on the reflectivity of the underlying metal layer, and the reflectance of chrome was lower than titanium. XPS determined that run 10 of EXAMPLE 3 was nearly stoichiometric Cr2O3 and exhibited an acceptable etch rate. That process is labeled Cr2O3 in this example. TABLE 4 provides thickness (in nm) for one-layer, two-layer, and three-layer dark mirror designs.

TABLE 4

| Material | 1-L | 2-L | 3-L |
|---|---|---|---|
| Ti | 10 | 10 | 10 |
| Cu | 100 | 100 | 100 |
| Ti | 30 | 30 | 30 |
| Cr | | 10 | 10.96 |
| CrON | 44.5 | 47 | 33.22 |
| Cr2O3 | | | 22.39 |

The two-layer design, which included a thin Cr layer under the CrON layer, slightly decreases the 355 nm reflectivity from the single layer design while not negatively impacting visible reflectivity or etch time. A much larger improvement in 355 nm reflectivity was observed in the three-layer design, which included a thin Cr layer under CrON and Cr203 layers. Reflectance from the electrode/top glass interface (e.g., conductive layer 128/first outer layer 118 boundary) was reduced to near 1%, and field intensity calculations showed the attenuation in the absorber layer (e.g., absorber layer 125) and top electrode layers (e.g., conductive layers 124a, 124b, 124c). TABLE 5 shows measured (e.g., Design) and simulated (e.g., s22) reflectivity at 355 nm, 620 nm, and 955 nm. With some compromise on optical color point, experimentally, and without intending to be bound by theory, it can be observed that the 355 nm reflectivity (R355) of 8.07 for the simulated was below (e.g., less than) that of the 355 nm reflectivity of 10.04 for the design, and the minimum reflectivity (Rmin) of 0.05 for the simulated was below (e.g., less than) that of the minimum reflectivity of 0.12 for the design. Thus, in accordance with embodiments of the disclosure, a dark mirror structure can include a 355 nm reflectivity of less than 25%, for example, less than 10%, and a reflectivity minimum of less than 1%. Moreover, the experimental film was observed to etch in less than 4 sec in Transene 1020 at 30° C., thus achieving all objectives with respect to etch time, visible reflectivity minimum, and 355 nm reflectivity, in accordance with embodiments of the disclosure.

TABLE 5

| Run | Rmin | WLmin | R355 | R620 | R950 |
|---|---|---|---|---|---|
| Design | 0.12 | 584.00 | 10.04 | 0.23 | 15.38 |
| s22 | 0.05 | 615.93 | 8.07 | 0.05 | 23.08 |

Accordingly, as described with respect to at least FIGS. 1-5, in some embodiments, a liquid lens 100 can include a first glass substrate (e.g., intermediate layer 120) and a structure (e.g., dark mirror structure 605) deposited on the first glass substrate. The structure can include an electrically conductive layer (e.g., conductive layer 128) deposited on the first glass substrate, and an electromagnetic absorber layer (e.g., absorber layer 125) deposited on the electrically conductive layer. As set forth in TABLE 5, the structure can define a reflectivity minimum of about less than 1% at a visible wavelength of from about 390 nm to about 700 nm, and a reflectively of about 25% or less at an ultra-violet wavelength of from about 100 nm to about 400 nm. Additionally, in some embodiments, the reflectivity minimum of about less than 1% in the visible wavelength can be at a narrower visible wavelength range of from about 550 nm to about 620 nm, and the reflectively of about 25% or less at the ultra-violet wavelength can be at a wavelength of about 355 nm. Moreover, in some embodiments, the reflectively at the ultra-violet wavelength can be about 10% or less.

As shown in FIG. 6, in some embodiments, the electrically conductive layer can include a first electrically conductive layer (e.g., conductive layer 124a) including Ti (Titanium) deposited on the first glass substrate, a second electrically conductive layer (e.g., conductive layer 124b) including Cu (Copper) deposited on the first electrically conductive layer, and a third electrically conductive layer (e.g., conductive layer 124c) including Ti (Titanium) deposited on the second electrically conductive layer. Likewise, in some embodiments, the electromagnetic absorber layer includes a first electromagnetic absorber layer (e.g., absorber layer 125a) including Cr (Chromium) deposited on the electrically conductive layer, a second electromagnetic absorber layer (e.g., absorber layer 125b) including CrON (Chromium Oxynitride) deposited on the first electromagnetic absorber layer, and a third electromagnetic absorber layer (e.g., absorber layer 125c) including a chromium oxide (e.g., Cr2O3 (Chromium (III) Oxide)) deposited on the second electromagnetic absorber layer.

As shown in FIG. 6 and TABLE 4, in some embodiments, a thickness “t1a” of the first electrically conductive layer (e.g., conductive layer 124a) can be about 10 nm, a thickness “t1b” of the second electrically conductive layer can be about 100 nm, and a thickness “t1c” of the third electrically conductive layer (e.g., conductive layer 124c) can be about 30 nm. Likewise, in some embodiments, a thickness “t2a” of the first electromagnetic absorber layer (e.g., absorber layer 125a) can be from about 10 nm to about 11 nm (e.g., 10.96 nm, TABLE 4), a thickness “t2b” of the second electromagnetic absorber layer (e.g., absorber layer 125b) can be from about 33 nm to about 34 nm (e.g., 33.22 nm, TABLE 4), and a thickness “t2c” of the third electromagnetic absorber layer (e.g., absorber layer 125c) can be from about 22 nm to about 23 nm (e.g., 22.39 nm, TABLE 4).

As shown in FIG. 9 and FIG. 10, in some embodiments, the electromagnetic absorber layer can enable exposure of the electrically conductive layer when etched in an etchant (e.g., etchant 901) including Transene 1020 at 30° C. in less than about 5 seconds.

In some embodiments, the liquid lens can include a second glass substrate (e.g., first outer layer 118) positioned on the electromagnetic absorber layer, and a bond (e.g., bond 135) defined at least in part by the structure. Additionally, as shown in FIG. 7 and FIG. 8, in some embodiments, the bond can hermetically seal the first glass substrate and the second glass substrate. In some embodiments, the liquid lens can include a cavity (e.g., cavity 104) defined at least in part by the bond. In some embodiments, a polar liquid (e.g., first liquid 106) and a non-polar liquid (e.g., second liquid 108) can be disposed within the cavity, and the polar liquid and the non-polar liquid can be substantially immiscible or immiscible such that a fluid interface between the polar liquid and the non-polar liquid forms a lens. In some embodiments, the liquid lens can include an interface (e.g., interface 110) defined between the polar liquid and the non-polar liquid.

In some embodiments, a method of operating the liquid lens can include subjecting the polar liquid and the non-polar liquid to an electric field. In some embodiments, the method can include changing a shape of the interface by adjusting the electric field to which the polar liquid and the non-polar liquid are subjected.

As shown in FIG. 5 and FIG. 6, in some embodiments, a method of manufacturing a liquid lens 100 can include applying a structure (e.g., dark mirror structure 605) to a first glass substrate (e.g., intermediate layer 120). In some embodiments, the applying the structure can include applying an electrically conductive layer (e.g., conductive layer 128, FIG. 5) of the structure to the first glass substrate and applying an electromagnetic absorber layer (e.g., absorber layer 125, FIG. 6) of the structure to the electrically conductive layer. As set forth in TABLE 5, in some embodiments, the structure can define a reflectivity minimum of about less than 1% at a visible wavelength of from about 390 nm to about 700 nm, and a reflectively of about 25% or less at an ultra-violet wavelength of from about 100 nm to about 400 nm. In some embodiments, the reflectivity minimum of about less than 1% at the visible wavelength can be at a narrower visible wavelength range of from about 550 nm to about 620 nm, and the reflectively of about 25% or less at the ultra-violet wavelength can be at a wavelength of about 355 nm. In some embodiments, the reflectively at the ultra-violet wavelength can be about 10% or less.

As further shown with respect to FIG. 5 and FIG. 6 and TABLE 4, in some embodiments, the applying the electrically conductive layer can include applying a first electrically conductive layer (e.g., conductive layer 124a) including Ti to the first glass substrate, applying a second electrically conductive layer (e.g., conductive layer 124b) including Cu to the first electrically conductive layer, and applying a third electrically conductive layer (e.g., conductive layer 124c) including Ti to the second electrically conductive layer, thereby forming an electrically conductive layer having a Ti/Cu/Ti structure. Likewise, in some embodiments, the applying the electromagnetic absorber layer can include applying a first electromagnetic absorber layer (e.g., absorber layer 125a) including Cr to the electrically conductive layer, applying a second electromagnetic absorber layer (e.g., absorber layer 125b) including CrON to the first electromagnetic absorber layer, and applying a third electromagnetic absorber layer (e.g., absorber layer 125c) including Cr2O3 to the second electromagnetic absorber layer, thereby forming an electromagnetic absorber layer having a Cr/CrON/Cr2O3 structure.

As shown in FIG. 9, in some embodiments, the method can include applying an etchant (e.g., etchant 901) including Transene 1020 at 30° C. to the electromagnetic absorber layer and exposing the electrically conductive layer based on the etching in less than about 5 seconds.

Moreover, as set forth with respect to FIGS. 1-3, in some embodiments, the method can include adding a polar liquid (e.g., first liquid 106) and a non-polar liquid (e.g., second liquid 108) to a cavity (e.g., cavity 104) of the liquid lens defined at least in part by the first glass substrate. In some embodiments, the polar liquid and the non-polar liquid can be substantially immiscible or immiscible, and the liquid lens can include an interface (e.g., interface 110) defined between the polar liquid and the non-polar liquid.

As shown in FIG. 7 and FIG. 8, in some embodiments, the method can include positioning a second glass substrate (e.g., first outer layer 118) on the electromagnetic absorber layer, and bonding the first glass substrate and the second glass substrate at least in part by laser beam welding the structure (e.g., with laser beam 701). For example, the method can include irradiating the electromagnetic absorber layer and/or the electrically conductive layer with electromagnetic radiation (e.g., using the laser beam 701). In some embodiments, the electromagnetic radiation has an ultra-violet wavelength of from about 100 nm to about 400 nm (e.g., 355 nm).

Accordingly, in some embodiments, the method can include subjecting the polar liquid and the non-polar liquid to an electric field, and changing a shape of the interface by adjusting the electric field to which the polar liquid and the non-polar liquid are subjected.

Embodiments and the functional operations described herein can be implemented in digital electronic circuitry, or in computer software, firmware, or hardware, including the structures disclosed in this specification and their structural equivalents, or in combinations of one or more of them. Embodiments described herein can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” or “controller” can encompass all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), to name just a few.

Computer readable media suitable for storing computer program instructions and data include all forms data memory including nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments described herein can be implemented on a computer having a display device, e.g., a CRT (cathode ray tube) or LCD (liquid crystal display) monitor, and the like for displaying information to the user and a keyboard and a pointing device, e.g., a mouse or a trackball, or a touch screen by which the user can provide input to the computer. Other kinds of devices can be used to provide for interaction with a user as well; for example, input from the user can be received in any form, including acoustic, speech, or tactile input.

Embodiments described herein can be implemented in a computing system that includes a back end component, e.g., as a data server, or that includes a middleware component, e.g., an application server, or that includes a front end component, e.g., a client computer having a graphical user interface or a Web browser through which a user can interact with implementations of the subject matter described herein, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Likewise, a “plurality” is intended to denote “more than one.”

Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the appended claims. Thus, it is intended that the present disclosure cover the modifications and variations of the embodiments herein provided they come within the scope of the appended claims and their equivalents.

It should be understood that while various embodiments have been described in detail with respect to certain illustrative and specific embodiments thereof, the present disclosure should not be considered limited to such, as numerous modifications and combinations of the disclosed features are possible without departing from the scope of the following claims.

1. A liquid lens comprising:
a substrate;
a structure disposed on the substrate and comprising an electrically conductive layer disposed on the substrate and an electromagnetic absorber layer disposed on the electrically conductive layer;
wherein the structure exhibits a reflectivity minimum of about less than 1% at a visible wavelength within a visible wavelength range of 390 nm to 700 nm, and a reflectively of about 25% or less at an ultra-violet wavelength within an ultra-violet wavelength range of 100 nm to 400 nm.

2. The liquid lens of claim 1, wherein the visible wavelength is within a narrowed visible wavelength range of 550 nm to 620 nm, and the ultra-violet wavelength is about 355 nm.

3. The liquid lens of claim 1, wherein the reflectively at the ultra-violet wavelength is about 10% or less.

4. The liquid lens of claim 1, wherein the electrically conductive layer comprises a first electrically conductive layer comprising Ti disposed on the first glass substrate, a second electrically conductive layer comprising Cu disposed on the first electrically conductive layer, and a third electrically conductive layer comprising Ti disposed on the second electrically conductive layer.

5. The liquid lens of claim 1, wherein the electromagnetic absorber layer comprises a first electromagnetic absorber layer comprising Cr disposed on the electrically conductive layer, a second electromagnetic absorber layer comprising CrON disposed on the first electromagnetic absorber layer, and a third electromagnetic absorber layer comprising Cr2O3 disposed on the second electromagnetic absorber layer.

6. The liquid lens of claim 1, wherein:
a thickness of the first electrically conductive layer is about 10 nm, a thickness of the second electrically conductive layer is about 100 nm, and a thickness of the third electrically conductive layer is about 30 nm; and
a thickness of the first electromagnetic absorber layer is from about 10 nm to about 11 nm, a thickness of the second electromagnetic absorber layer is from about 33 nm to about 34 nm, and a thickness of the third electromagnetic absorber layer is from about 22 nm to about 23 nm.

7. The liquid lens of claim 1, wherein etching the electromagnetic absorber layer in Transene 1020 at 30° C. exposes the electrically conductive layer in less than about 5 seconds.

8. The liquid lens of claim 1, comprising:
a second substrate disposed on the electromagnetic absorber layer such that the structure is disposed between the substrate and the second substrate; and
a bond defined at least in part by the structure;
wherein the bond hermetically seals the substrate and the second substrate.

9. (canceled)

10. The liquid lens of claim 8, comprising:
a cavity defined at least in part by the bond; and
a first liquid and a second liquid disposed within the cavity;
wherein an interface between the first liquid and the second liquid defines a lens of the liquid lens.

11. (canceled)

12. A method of manufacturing a liquid lens, the method comprising:
applying a structure to a glass substrate by applying an electrically conductive layer of the structure to the glass substrate and applying an electromagnetic absorber layer of the structure to the electrically conductive layer;
wherein the structure exhibits a reflectivity minimum of about less than 1% at a visible wavelength within a visible wavelength range of 390 nm to 700 nm, and a reflectively of about 25% or less at an ultra-violet wavelength within an ultra-violet wavelength range of 100 nm to 400 nm.

13-20. (canceled)

21. A bonded article comprising:
a first substrate;
a second substrate; and
a structure disposed between the first substrate and the second substrate and comprising an electrically conductive layer and an electromagnetic absorber layer;
wherein the structure exhibits a reflectivity minimum of about less than 1% at a visible wavelength within a visible wavelength range of 390 nm to 700 nm, and a reflectively of about 25% or less at an ultra-violet wavelength within an ultra-violet wavelength range of 100 nm to 400 nm.

22. The bonded article of claim 21, wherein at least one of the first substrate or the second substrate comprises a glass-based material.

23. The bonded article of claim 21, wherein the visible wavelength is within a narrowed visible wavelength range of 550 nm to 620 nm, and the ultra-violet wavelength is about 355 nm.

24. The bonded article of claim 21, wherein the reflectively at the ultra-violet wavelength is about 10% or less.

25. The bonded article of claim 21, wherein the electrically conductive layer comprises a first electrically conductive layer comprising Ti disposed on the first substrate, a second electrically conductive layer comprising Cu disposed on the first electrically conductive layer, and a third electrically conductive layer comprising Ti disposed on the second electrically conductive layer.

26. The bonded article of claim 21, wherein the electromagnetic absorber layer comprises a first electromagnetic absorber layer comprising Cr disposed on the electrically conductive layer, a second electromagnetic absorber layer comprising CrON disposed on the first electromagnetic absorber layer, and a third electromagnetic absorber layer comprising Cr2O3 disposed on the second electromagnetic absorber layer.

27. The bonded article of claim 25, wherein:
a thickness of the first electrically conductive layer is about 10 nm, a thickness of the second electrically conductive layer is about 100 nm, and a thickness of the third electrically conductive layer is about 30 nm; and
a thickness of the first electromagnetic absorber layer is from about 10 nm to about 11 nm, a thickness of the second electromagnetic absorber layer is from about 33 nm to about 34 nm, and a thickness of the third electromagnetic absorber layer is from about 22 nm to about 23 nm.

28. The bonded article of claim 21, wherein etching the electromagnetic absorber layer in Transene 1020 at 30° C. exposes the electrically conductive layer in less than about 5 seconds.

29. The bonded article of claim 21, wherein the bonded article comprises a hermetically sealed package and a liquid disposed within the hermetically sealed package.

30. (canceled)

31. The bonded article of claim 26, wherein:
a thickness of the first electrically conductive layer is about 10 nm, a thickness of the second electrically conductive layer is about 100 nm, and a thickness of the third electrically conductive layer is about 30 nm; and
a thickness of the first electromagnetic absorber layer is from about 10 nm to about 11 nm, a thickness of the second electromagnetic absorber layer is from about 33 nm to about 34 nm, and a thickness of the third electromagnetic absorber layer is from about 22 nm to about 23 nm.
